(19) United States
(12) Patent Application Publication
(10) Pub. No.: US 2005/0055232 A1
(43) Pub. Date: Mar. 10, 2005

(54) Personal information system and method

(76) Inventor: Philip Yates, Wilsonville, OR (US)

Correspondence Address: Philip Yates, 30240 SW Parkway Ave., #9, Wilsonville, OR, 97070, US

(21) Appl. No.: 10/852,599

(22) Filed: May 24, 2004

Related U.S. Application Data
(60) Provisional application No. 60/472,918, filed on May 23, 2003.

(51) Int. Cl. G06F 17/60

(52) U.S. Cl. 705/1

(57) ABSTRACT

A personalized information system and method assists users in collecting information regarding goals and other interests by periodically sending related messages containing repeated questions to users. A user can select from a collection of predetermined questions, can originate questions, and can rely upon coaches or experts to develop related questions. The collected information can be reviewed by the user, a coach, or other expert to alter the questions, provide suggestions, or take other action. Information collection can be aided by allowing the user to respond to the questions directly within received e-mails without having to log onto another system. Vendors can also market goods and services to the users based on the collected information along with other financial transaction information as permitted by the users. Some implementations also provide for introductions between users based upon shared interests and other factors.

### BACKGROUND OF THE INVENTION

1. Field of the Invention

The present invention is directed generally to systems for communication and data collection and, more particularly, to systems for communication and data collection regarding activities of a personal nature.

2. Description of the Related Art

Journals, logbooks, electronic diaries, and other forms of recordkeeping systems have been used to track progress or record observations related to goals and other interests. Unfortunately, these conventional approaches can be inconvenient to use and require a certain degree of diligence that are not possessed by some who would otherwise benefit. In pursuing goals and other interests, novices could benefit from guidance from experts or coaches, however, access to experts and coaches can be limited due to expense, separation distances, scheduling conflicts, and other factors.

### BRIEF SUMMARY OF THE INVENTION

The present invention resides in a data system for communication with a communication device. The data system comprises a database containing messages and scheduling data, and a communication exchange configured to repeatedly send the same message of the database to the communication device according to the scheduling data. In one embodiment the data system is for use with a communication device configured to receive e-mails, and the communication exchange is configured to send the same message of the database in the form of e-mails to the communication device, and to receive email responses from the communication device. The same message may be in the form of a question, and the communication exchange may be configured to format the e-mails to provide capability to respond to the question contained in the e-mails as part of display of the e-mails on the communication device. Alternatively, the communication exchange may be configured to format the e-mails in a markup language to provide capability to respond to the question within the e-mails using check boxes and submit buttons within the e-mails.

The communication exchange may send the same message to the communication device in accordance with a predetermined schedule. The predetermined schedule may be daily.

The data system may comprise a database containing data including messages, at least some of the messages containing questions; a communication exchange configured to repeatedly send the message, with at least some being sent more than once, to one of the communication devices of one of the persons registered with the data system as a user of the data system to repeatedly solicit responses from the user to be sent to the data system by the user from the one of the communication devices, and to receive the responses sent to the data system from the communication device of the user; and a coach system configured to provide to another one of the persons registered with the data system as a coach access to review the responses sent to the data system from the communication device of the user. The communication exchange may further be configured to format the messages for display on the communication device of the user one or more of the repeated questions of the messages with a graphical representation of prior responses to the one or more repeated question. The coach system may be configured to generate at least one subsequent message to be sent to the communication device of the user by the communication exchange based upon the responses received by the data system from the communication device of the user. The coach system may also be configured to provide access for the coach to the database to modify the messages of the database to be sent to the communication device of the user.

In one embodiment, the data system is for communication with communication devices of entities, and includes a database containing data including messages, at least some of the messages containing questions; and a communication exchange configured to repeatedly send the messages, with at least some being sent more than once, to one of the communication devices of one of the entities being a person registered with the data system as a user of the data system to repeatedly solicit responses from the user to be sent to the data system by the user from the one of the communication devices, and to receive the responses sent to the data system from the communication device of the user. The data system further includes a coach system configured to provide to another one of the entities being a person registered with the data system as a coach access to review the responses sent to the data system from the communication device of the user; a financial transaction system configured to provide the user capability to make purchases using at least one of credit cards and debit cards, and to collect information regarding such purchases; and a vendor system configured to provide to another one of the entities registered with the data system as a vendor access to review the responses received by the communication exchange from the communication device of the user, and access to review the information regarding purchases of the user and to send solicitations to the user regarding at least one of products and services for possible purchase by the user based at least in part on the reviews of the vendor. In one aspect, the invention is a personal information system comprising a communication device configured to be used by a user, and a data system including a database storing data to be sent to the communication device more than once, the data including questions to be responded to more than once by the user of the communication device. The personal information system may comprise a network with the communication device and the data system communicatively coupled to the network. The network may be a wireless network. The communication device may be a cellular telephone or a wireless personal data assistant. Alternatively, the network may be a computer data network. Further, the communication device may be a computer workstation and the data system a computer server. The computer network may be the Internet.

Other embodiments may include a data system for communication with communication devices of entities, with the data system comprising a database containing data including messages, at least some of the messages containing questions, a communication exchange, and a vendor system. The communication exchange is configured to repeatedly send the messages, with at least some being sent more than once, to one of the communication devices of one of the entities registered with the data system as a user of the data system to repeatedly solicit responses from the user to be sent to the data system by the user from the communication device of the user, and to receive the responses sent to the data system by the user from the communication device of the user. The vendor system is configured to provide to another one of the entities registered with the data system as a vendor access to review the responses sent to the data system by the user from the communication device of the user, and to send solicitations to the user regarding at least one of products and services for possible purchase by the user based at least in part on the responses received by the communication exchange from the communication device of the user. The data system may have the vendor system configured to generate at least one subsequent message to be sent to the communication device of the user by the communication exchange based upon the responses received by the communication exchange from the communication device of the user. The data system may include a financial transaction system configured to provide the user capability to make purchases using at least one of credit cards and debit cards and to collect information regarding such purchases.

Alternatively, the data system may also comprise a database containing user data regarding the users, an introduction system and communication exchange. The introduction system may be configured to search the user data to determine if possible matches of the user data exist between at least two of the users and to transmit a message of introduction to at least one of the matched users if a match exists, and the communication exchange may be configured to electronically send a series of messages to communication devices of selected ones of the users soliciting a series of responses, each response to contain a portion of the user data to be stored in the database.

The present invention also resides in a method comprising repeatedly transmitting a message via e-mail to a workstation of a user wherein each transmission of the e-mail message solicits a response from the user containing information related to the particular transmissions to the user; electronically receiving responses from the user to the repeated transmissions of the message, the responses containing the information solicited from the user; and including at least some of the information solicited from the user in subsequent repeated transmissions of the message to the user. The method may have the message contain questions and comprising generating at least one of modifications to the questions and additional questions to be added to the message based upon prior responses received from the user. At least some of the information may be done by including a graphical representation of the information within the repeated e-mail transmissions of the message.

Alternatively, the method comprises storing data regarding a person in a database as a user; storing data in the database of a person as a coach of the user; repeatedly transmitting an electronic based message to the user to solicit responses containing information related to the particular transmission of the message to the user; electronically receiving responses from the user to the repeated transmissions of the message, the responses containing the information solicited from the user; and modifying subsequent transmissions of the electronic based message based upon at least one review by the coach of the received information solicited from the user.

In yet another alternative, the method may comprise electronically storing questions to be sent by e-mail to a person; electronically storing a frequency of when the questions will be sent to the person; sending selected ones of the questions by e-mail to the person at the stored frequency; receiving responses containing information from the person to the questions; and sending to the person by e-mail at least one of modifications to the questions or additional questions based upon the received information.

Yet another alternative method comprises repeatedly transmitting a message via e-mail to a workstation of a user wherein each transmission of the email message solicits a response from the user containing information related to the particular transmissions to the user; electronically receiving responses from the user to the repeated transmissions of the message, the responses containing the information solicited from the user; and sending at least one message to the workstation of the user soliciting the user to purchase based at least in part upon the information solicited from the user. The method may include monitoring at least one of credit and debit card purchases of the user to collect financial transaction information, and the sending the at least one message to the workstation of the user soliciting the user to purchase may also be based at least in part upon at least a portion of the collected financial transaction information.

Another method comprises electronically registering a coach, the coach having a team of members; periodically sending e-mails to the team members soliciting information; electronically receiving solicited information from the team members; electronically registering a vendor; sending at least one vendor marketing message to the team members based at least in part upon at least a portion of the received solicited information from the team members; collecting from the vendor a fee based at least in part upon the sending at least one vendor marketing message to the team members; and distributing at least a portion of the fee to the team members.

Alternatively, the method may comprise electronically sending messages to users, each message soliciting information containing a portion of predetermined user data for the receiving user until all portions of the user data for each user have been solicited by one of the messages; electronically receiving responses from the users, each of the responses containing the portion of user data solicited; storing the received portions of user data until each user has complete user data with all portions of user data stored; searching complete portions of user data for a portion of the users to determine if matches exist; and notifying at least one of the matching users that a match exists.

Other features and advantages of the invention will become apparent from the following detailed description, taken in conjunction with the accompanying drawings.

### BRIEF DESCRIPTION OF THE SEVERAL VIEWS OF THE DRAWING(S)

FIG. 1 is a block diagram of an implementation of a personal information system.

FIG. 2 is a block diagram showing more detail of a user database, which is part of the personal information system shown in FIG. 1.

FIG. 3 is a flowchart of a method for using the personal information system shown in FIG. 1 to collect information related to a goal or other interest and to target market based at least in part upon the collected information.

FIG. 4 is a flowchart of a method for using the personal information system shown in FIG. 1 to use information collected related to a goal or other interest and information associated with a purchase to target market.

FIG. 5A is a flowchart of a method for using the personal information system shown in FIG. 1 to recruit an expert and enlist members of the expert's group to enlist a vendor to charge a fee.

FIG. 5B is a flowchart of a method using the personal information system to target market based upon collected information regarding a user and to credit user participation in the target marketing.

FIG. 5C is a flowchart of a method using the personal information system for coach involvement with user information collection.

FIG. 6 is a block and flow diagram of an exemplary implementation of a personal information system.

FIG. 7 is a block and flow diagram showing further aspects related to a registration module, which is part of the personal information system shown in FIG. 6.

FIG. 8 is a block and flow diagram showing further aspects related to an imail generator module, which is part of the personal information system shown in FIG. 6.

FIG. 9 is a block and flow diagram showing further aspects related to a user's public home page, which is part of the personal information system shown in FIG. 6.

FIG. 10 is a block and flow diagram showing further aspects related to question sets, which are part of the personal information system shown in FIG. 6.

FIG. 11 is a block and flow diagram showing further aspects related to a question list module, which is part of the personal information system shown in FIG. 6.

FIG. 12 is a block and flow diagram showing further aspects related to an introduction module, which is part of the personal information system shown in FIG. 6.

FIG. 13 is a block and flow diagram showing aspects related to a marketing module, which is part of the personal information system of FIG. 6.

FIG. 14 is a block and flow diagram showing further aspects related to a coach module, which is part of the personal information system shown in FIG. 6.

FIG. 15 is a screenshot of an exemplary imail having questions to be answered by user an implementation of the personal information system.

FIG. 15A is a screenshot of another exemplary imail having a question to be answered by user and displaying a weight record of the user.

FIG. 16 is a screenshot of a response screen after a user's answers are submitted to the personal information system.

FIG. 17 is a screenshot of a login screen of an implementation of the personal information system.

FIG. 18 is a screenshot of the welcome page of an implementation of the personal information system.

FIG. 19 is a screenshot of a chosen questions page of an implementation of the personal information system.

FIG. 20 is a screenshot of a suggested questions page of an implementation of the personal information system.

FIG. 21 is a screenshot of a detailed menu of the suggested questions page of FIG. 20.

FIG. 22 is a screenshot of a first question page of an implementation of the personal information system.

FIG. 23 is a screenshot of a second question page of an implementation of the personal information system.

FIG. 24 is a screenshot of a frequency table page of an implementation of the personal information system.

FIG. 25 is a screenshot of personal information page of an implementation of the personal information system.

FIG. 26 is a screenshot of a preferences page of an implementation of the personal information system.

FIG. 27 is a screenshot of a help menu page of an implementation of the personal information system.

FIG. 28 is a screenshot of an advantages help page of an implementation of the personal information system.

FIGS. 29A and 29B are screenshots of further material found in the advantages help page of FIG. 28.

FIG. 30 is a screenshot of a question list help page of an implementation of the personal information system.

FIG. 31 is a screenshot of further material found in the question list help page of FIG. 30.

FIG. 32 is a screenshot of a coach help page of an implementation of the personal information system.

FIG. 33 is a screenshot of a memail help page of an implementation of the personal information system.

FIG. 34 is a screenshot of a recordkeeping help page of an implementation of the personal information system.

FIG. 35 is a screenshot of a self-knowledge help page of an implementation of the personal information system.

FIG. 36 is a screenshot of a mood and pain help page of an implementation of the personal information system.

FIG. 37 is a screenshot of a designing questions help page of an implementation of the personal information system.

FIG. 38 is a screenshot of a question frequency help page of an implementation of the personal information system.

FIG. 39 is a screenshot of a question type help page of an implementation of the personal information system.

FIG. 40 is a screenshot of further material of the question type help page of FIG. 39.

FIG. 41 is a screenshot of an answering memail help page of an implementation of the personal information system.

FIG. 42 is a screenshot of a how data for life works help page of an implementation of the personal information system.

FIG. 43 is a screenshot of an alternative logon page of an implementation of the personal information system.

### DETAILED DESCRIPTION OF THE INVENTION

As will be discussed in greater detail herein, a personalized information system and method disclosed herein assists users in tracking progress of their pursuit of personal goals or interests. The system sends periodic messages to the users via e-mail or by other communication means such as cell phone, wireless personal data assistant, telephone, etc. The messages can include questions, instructions, words of encouragement related to the user's goals or interests, as well as advertisements, hyperlinks and any other form of information.

Some of the messages contain questions that are repeated on a periodic basis in order to collect information over a span of time to track progress toward a goal or record change in a behavior or characteristic of interest, or to maintain personal information, e.g. diary-like text entries. In initially choosing a set of questions that will be repeated, a user can select from a collection of predetermined questions, can originate questions, and can rely upon coaches or experts to develop questions related to the user's goals or interests. Once a set of questions is selected, the questions are periodically sent to the user to collect responses to the questions. The information collected from repeated answers given by the user in response to repeatedly receiving the set of questions can be used for other purposes. For instance, the goal or interest related information can be reviewed by the user through use of generated reports. A coach or expert that the user has entrusted can also review the goal or interest related information. Based upon these reviews, the questions can be altered, suggestions can be made, or other actions can be taken regarding pursuit of the goal. Non-goal related information can be reviewed by the user for personal reflection or as a need arises to check some facet of personal history or other non-goal interest.

In some implementations, collection of the goal or interest related information is aided by e-mail techniques that allow the user to respond to the questions by manipulating objects (such as check boxes and submit buttons) directly embedded within received e-mails without having to log onto a system different than the e-mail system being used by the user. In other implementations, the user clicks on one or more links to activate browser available web pages to assist in collection of information.

The goal or interest related information can also be used by vendors for target marketing of various goods and services to the user. In some implementations the user determines the extent of such target marketing by indicating willingness to receive ads and other information from the vendors. In some implementations target marketing of the users may also be done through the use of financial transaction information collected through means such as credit/debit card use and responses to questions directed to the users.

Some implementations also provide for introductions between users of the personalized information system based upon shared interests and other factors. Use of these various facets of the personalized information system (including collection of diary data, goal or interest related information, coach or expert input, vendor target marketing, collection of financial transaction information, and facilitating introductions between users of the system) can be used in an integrated approach to capitalize on numerous synergies that can result.

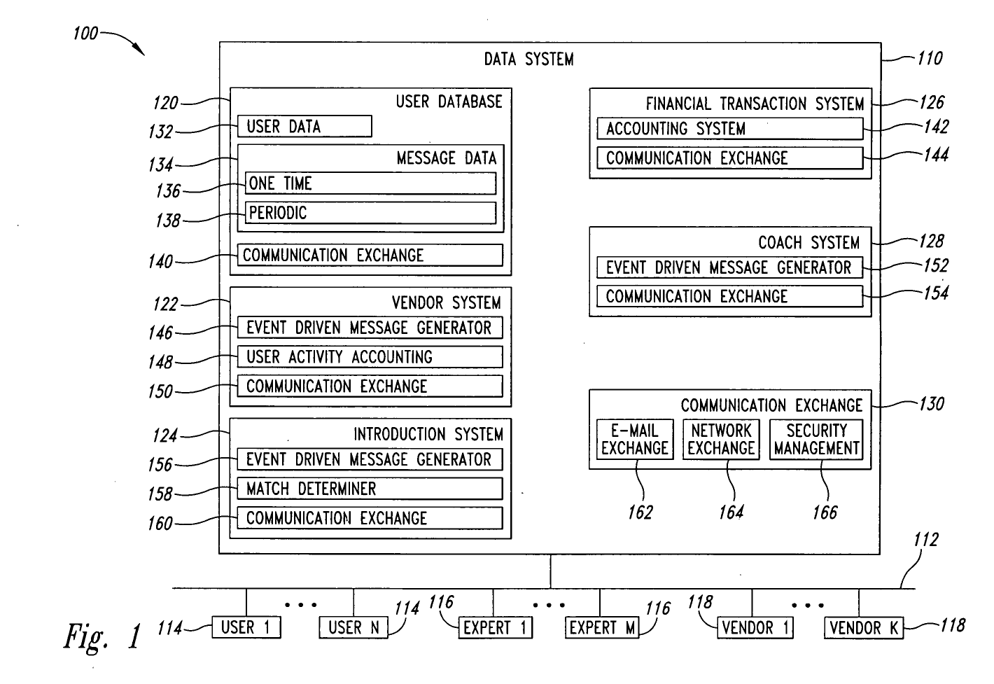

As depicted in FIG. 1, an implementation of a personalized information system 100 is shown as having a data system 110 electronically coupled by a network 112 to a plurality of user workstations 114, a plurality of expert workstations 116, and a plurality of vendor workstations 118. In some implementations workstation refers to a computer workstation whereas in other implementations, workstation refers to other communication devices such as a cell phone, a personalized data assistant, other wireless communication devices, other telephonic based communication devices, or other networked devices. Users, experts, and vendors that use the system 100 typically use one of the plurality of user workstations 114, one of the plurality of expert workstations 116, and one of the plurality of vendor workstations 118, respectively, to communicate with the data system 110 through use of one or more e-mail systems (either inherently found within the data system 110 or otherwise provided) electronically coupled with the network 112 or by directly logging onto the data system via the network, for example, through use of a network browser.

As described above, the user typically is one who seeks to track progress toward a personal goal, keep track of personally meaningful information, meet others, financially transact, or rely upon an expert or coach (either individually or in a team context). An expert or coach is generally one who has reason for influencing the behavior of others as individuals or as members of a group. The expert or coach generally would be involved in a team environment regarding a particular subject matter such as sports (e.g. a sports coach), health (e.g. a doctor), career (e.g. a manager), religion (e.g. a minister), entertainment (e.g. a director), travel (e.g. a travel agent), domestic interests (e.g. a marriage counselor), aspects of home (e.g. a grandparent), architecture (e.g. a building manager or designer), education (e.g. a teacher), crafts or hobbies (e.g. an instructor or local expert), finance (e.g. a credit counselor), publishing (e.g. an ezine distributor) or other.

The data system 100 includes a user database 120, a vendor system 122, an introduction system 124, a financial transaction system 126, a coach system 128 (to include also other activity by experts), and a communication exchange 130. The user database 120 includes user data 132, message data 134, and a communication exchange 140. The user data 132 involves both system and personal data that is used in communication with users, experts, and vendors. For instance, the user data 132 can include goal, personal interest, marketing, or financial related information regarding a particular user or group of users. The user data 132 can also include various attributes and preferences such as for reporting on progress regarding goals, accepting guidance from experts, accepting advertising from vendors, having information collected, having information displayed on a “user home page”, receiving targeted marketing, and allowing introductions to be made with other users. The user data 132 can also include graphical representations of past responses which can be included in a periodic message. The message data 134 has data that is to be included in messages sent to users of the user workstations 114. Many of the messages contain questions to be viewed by the users on a one-time or a periodic basis in order to collect information regarding user profile data, user goals, user interests, user purchases, or user introductions. Question frequency can be set on fixed schedules, e.g. one-time only, every Monday, every month on the 25th, etc. Or question generation can dependent upon logical tests, e.g. only if the user has already responded to a particular other question, or only if the user has responded with a particular response to a specific prior question.

The message data 134 includes one-time message data 136, that is, questions to be sent to particular one or more users only once. Message data 134 also includes periodic message data 138 for questions to be sent to particular one or more users on a periodic basis. An example of use of one-time questions is in the collection of extensive profile data on a user who prefers to answer a number of small groups of questions over an extended period of time (such as once a week or a month) instead of answering all the questions in one lengthy period (such as a two hour on line session). An example of use of a periodic question is the collection of periodic responses concerning a user's particular behavior, e.g. how many cigarettes did the user smoke that day. Periodic message data 138 can include graphical representations of prior responses to periodic questions, as are stored in the user data 132.

Through use of the user workstations 114, the expert workstations 116, and the vendor workstations 118, both the one-time questions and the periodic questions can be chosen from pre-written lists of questions which are displayed on a web page on a website of the data system 110. These pre-written questions can be originated by administrators of the data system 110, by users, by experts, and/or by vendors for particular one or more users, with specified periodic frequencies and with specified logical tests. The user database 120 further has a communication exchange 140 to facilitate communication with the communication exchange 130. In some implementations, the data system 110 can be a single server computer, whereas in other implementations, the various components such as the user database 120, the vendor system 122, the introduction system 124, the financial transaction system 126, the expert system 128, and the communication exchange 130 can be other combinations of computer systems such as individual computers.

The vendor system 122 includes an event driven message generator 146, a user activity accounting 148, and a communication exchange 150. The event driven message generator 146 communicates with the user database 120 and in some implementations other components of the data system 110 such as the financial transaction system 126, the introduction system 124, the expert system 128, and the communication exchange 130 to ascertain whether predetermined events have occurred. Upon determination that an event has occurred, the event driven generator 146 typically sends a message to one of the user workstations 114 associated with a particular user for targeted marketing of the user. At times, the vendor system 122 can communicate with the financial transaction system 126 to derive financial transaction information regarding financial activity of preselected users. This derived financial transaction information can then be stored in the user activity accounting 148 for use with targeted marketing messages to be sent at appropriate times to the preselected users based upon their financial activity. The vendor system 122 uses the communication exchange 150 with other components of the data system 110 depending upon the particular architecture of the implementation of the data system.

The introduction system 124 includes an event driven message generator 156, which can send messages based upon occurrences of predetermined events to users. The purpose of the message would be either for notification or information collection. Information collection would generally be used to identify a user's personality profile. A match determiner 158, as part of the introduction system 124, is used to find occurrences of desired patterns in data in the personality profiles associated with one or more of the users. If the match determiner 158 finds that two or more users have matching or otherwise mutually relevant personality profiles, the event driven message generator 156 will send a message to each matched user, thereby allowing possibilities of subsequent introductions to be made between the users. A communication exchange 160 is used by the introduction system 124 to communicate between other components of the data system 110, and between users who have been matched by the match determiner 158.

The financial transaction system 126 includes an accounting system 142, which can be typically found with credit or debit cards or other means of financial transactions conventionally known. The financial transaction system 126 includes a communication exchange 144 to communicate with other components of the data system 110.

The coach system 128 includes an event driven message generator 152 that contains predetermined messages, typically including questions, to be sent to preselected users based upon occurrences of predetermined events. Coaches or other experts using the expert workstations 116 can communicate with the coach system 128 through the communication exchange 130 and a communication exchange 154. The coach or expert can manually select messages to be used with the event driven message generator 152. The event driven message generator 152 can also generate messages based on upon logical tests, e.g. only if the user has already responded to a particular other question, or only if the user has responded with a particular response to a specific prior question. Coaches and experts also have an option to be notified by the event driven message generator 152 when preselected events occur associated with users that the coaches and experts are advising. The coaches and experts can then contact the users directly through the expert workstations 116 or by other communication means.

The communication exchange 130 includes an e-mail exchange 162, a network exchange 164, and a security management 166. The e-mail exchange 162 is used in some implementations to communicate with the users through emails so that the users can reply directly in e-mails rather than logging onto a system. A network exchange 164 in some implementations can be used to communicate with users when e-mail access is limited or is not available to sufficiently support communication. The security management 166 allows for permission or denial of access to various components of the data system 110 and various services and functions provided by the data system depending upon what permission is granted to users, coaches or experts, and vendors accessing the data system.

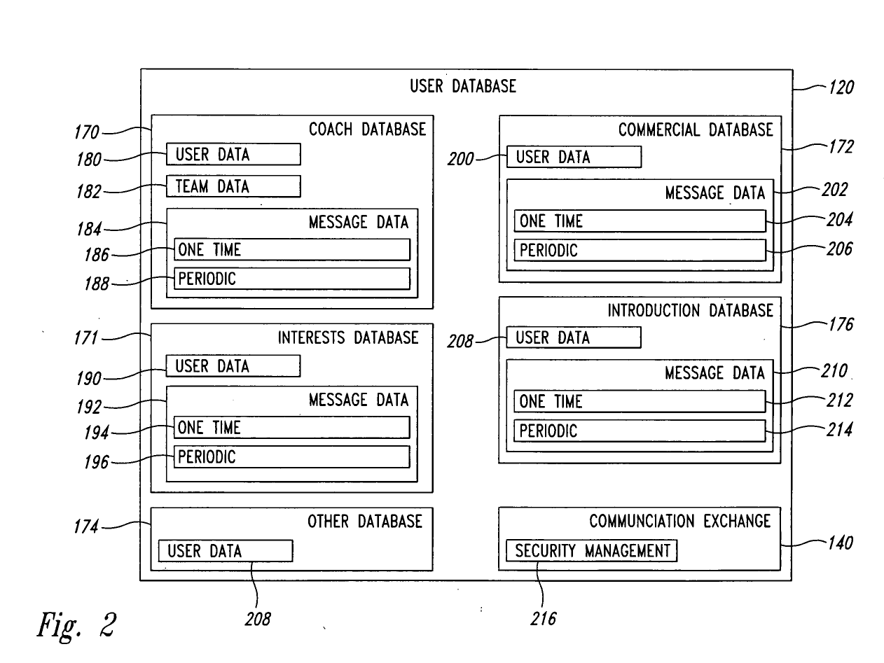

The user database 120 is further depicted in the FIG. 2 as having a coach database 170, an interests database 171, a commercial database 172, an other database 174, and an introduction database 176. The coach database 170 includes user data 180 and team data 182 to allow for collection and storage of data related to particular individual users and designated groups of individuals, respectively. The coach database 170 further includes message data 184 that has one-time message data 186 and periodic message data 188. The message data 184 can be configured by both users, coaches or experts, and vendors for periodic transmission primarily to users of messages containing notification, questions, suggestions, advice and other textual, markup language based, multimedia based or other information.

The interests database 171 includes user data 190, which can be used to store financial transaction information regarding particular users, and message data 192 having one-time message data 194 and periodic message data 196. The message data 192 can be particularly used by vendors to periodically send various messages to users based in part upon transaction information contained in the user data 190.

The commercial database 172 includes user data 200, which can be used to store financial transaction information regarding particular users, and message data 202 having one-time message data 204 and periodic message data 206. The message data 202 can be particularly used by vendors to periodically send various messages to users based in part upon transaction information contained in the user data 200.

The other database 174 contains user data 198 that may be used for such things as a homepage for a particular user. Such data can include information regarding hobbies or any other data that the user has designated for display on the user's homepage.

The introduction database 176 includes user data 208, which can be used to store profile information regarding particular users, and message data 210 having one-time message data 212 and periodic message data 214. The message data 210 can be particularly used by the match determiner 158 upon location of matched data patterns associated with users to notify the associate users of the existence of such data patterns.

The communication exchange 140 includes a security management 216 to allow or deny particular users, coaches or experts, and vendors access to particular data contained within the coach database 170, the interests database 171, the commercial database 172, the other database 174, and the introduction database 176.

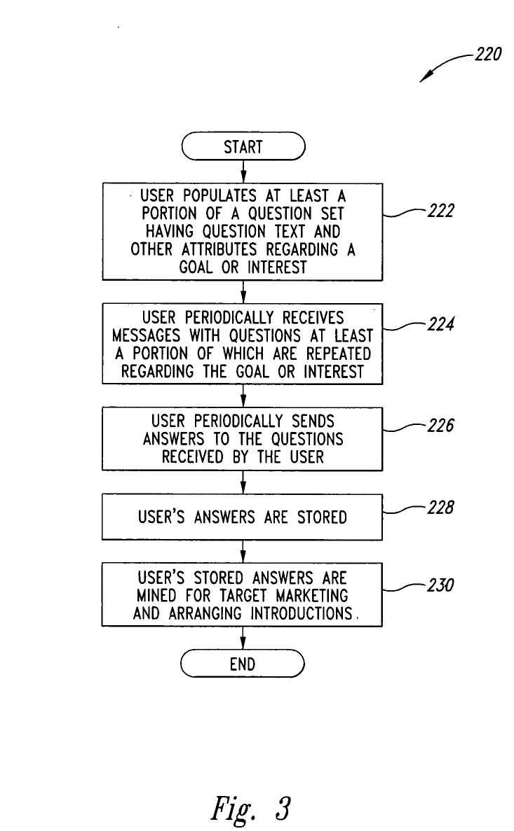

A method 220 for use of the personal information system 100 is shown in FIG. 3 as starting with the user populating at least a portion of a set of questions having text and other attributes regarding a goal or interest (step 222). The question attributes can include the text of the questions to be transmitted, the frequency of a periodic question (e.g. every day), the question type (e.g. multiple choice), and duration and other scheduling information regarding transmission. The question attributes can be stored in the user data 132 and the message data 134 of the user database 120. Based upon the stored question attributes, the user data system 110 periodically transmits the one-time message data 136 and the periodic message data 138 to one of the user workstations 114 wherein the user periodically receives questions, at least a portion of which are repeated, regarding a goal or interest (step 224). In response to periodically receiving questions, the user uses one of the user workstations 114 to periodically send answers to the data system 110 regarding the goal or interest (step 226). The user's answers are then stored (step 228) in the user data 132. Data from the user's answers is then mined by vendors using at least one of the vendor workstations 118 and/or by the vendor system 122 to transmit targeted marketing messages to the user (step 230) and the method 220 ends.

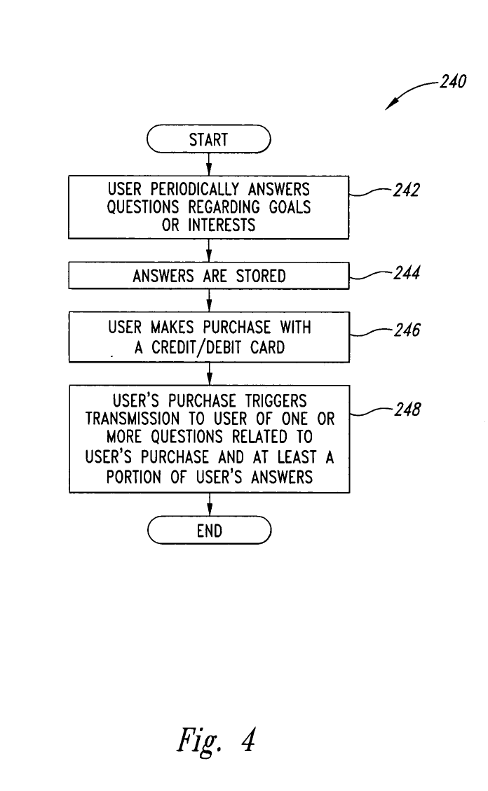

A method 240 for use of the personal information system 100 is shown FIG. 4 as starting with a user periodically answering questions regarding a goal or interest (step 242). The answers are stored in the user data 132 (step 244). The user makes a financial purchase through the financial transaction system 126 generally using a credit or debit card (step 246). The event driven message generator 146 of the vendor system 122 is then triggered to transmit to the user one or more questions or messages related to the user's purchase. The question or message is based at least upon a portion of the user's answers stored in the user data 132 (step 248) and the method 240 ends.

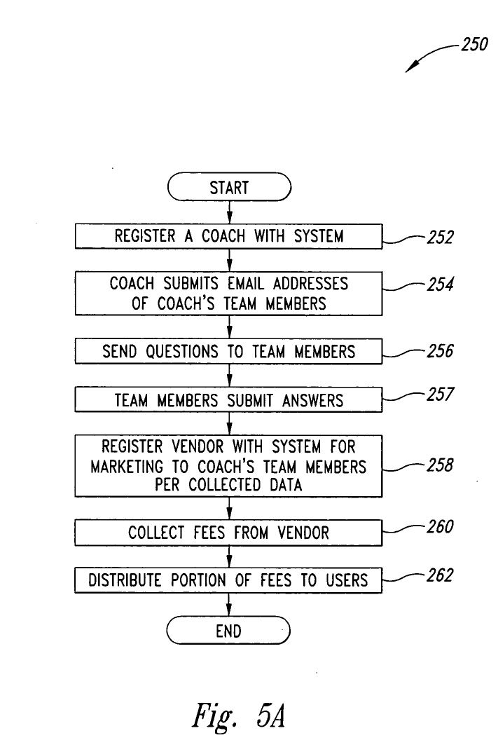

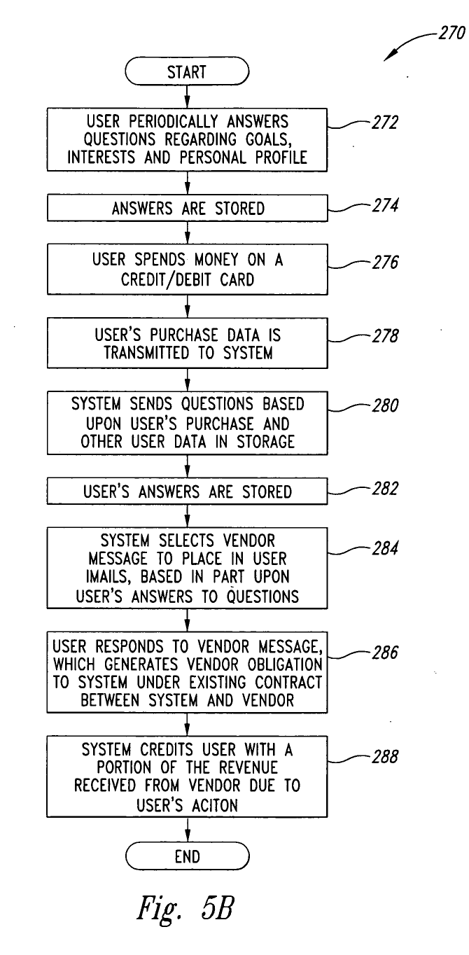

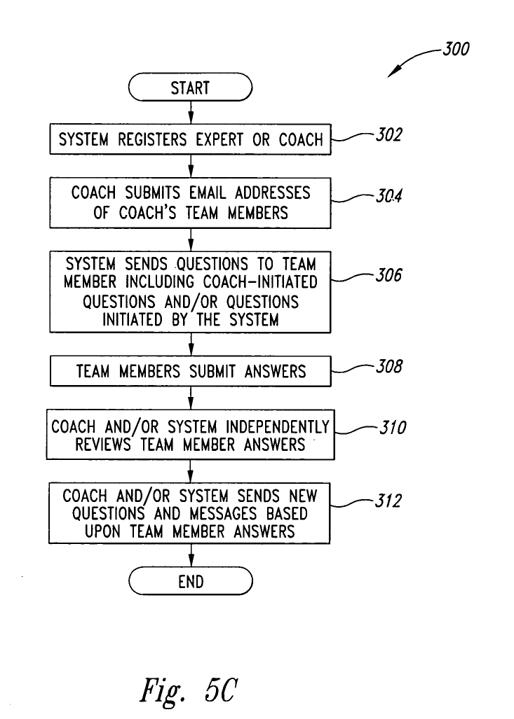

A method 250 for use of the personal information system 100 is shown FIG. 5A as starting with a coach or expert being registered to use the personal information system to provide guidance and other advice to members of a group associated with the coach or expert (step 252). E-mail addresses of the members of the coach's group are then entered into the user data 132 (step 254) by the coach, expert, or other such as a system administrator. The coach or expert and/or the coach system 128 sends questions to the members of the coach's group (step 256). The group members respond by sending answers to the personal information system 110 (step 257) either through e-mails or by logging on to the personal information system. A vendor is registered with the data system 110 through the communication exchange 130 for marketing to the members of the coach's group by sending messages to the members using the event driven message generator 146 of the vendor system 122 (step 258). The user activity accounting 148 tracks vendor marketing activities of the group members and the vendor is assessed fees to be paid by the vendor through the vendor system 148 to the business operating and/or owning the data system 110 (step 260). A portion of the paid fees are then paid out to the team members (step 262) through the financial transaction system 126 based upon the user activity accounting 148 assessment of involvement of the individual group members with the vendor's marketing and the method 250 ends.

A method 270 for use of the personal information system 100 is shown FIG. 5B as starting with a user periodically answers questions regarding goals, interests and personal profile (step 272). The answers are then stored in the user data 132 (step 274). The user uses the financial transaction system 126 to spend money with a credit/debit card (step 276). The user's purchase data is transmitted to one or more components of the data system 110 (step 278) such as the vendor system 122, the coach system 128, or the user database 120. One or more components of the data system 110 then send questions based upon users purchase and other user data stored in the user data 132 (step 280). User's responds and the answers are stored in the user data 132 (step 282). One or more components of the data system 110, such as the vendor system 122, select one or more vendor messages to be sent to the user in an imail (step 284), based in part upon the user answers. The user responds to vendor message, which generates a vendor obligation (step 286) as tracked by the user activity accounting 148 of the vendor system 122 under an existing contract with the vendor. The user activity accounting 148 further credits (step 288) the user with a portion of revenue received from the vendor obligation based on user involvement with the vendor messages such as viewing, responding, and/or purchasing and the method 270 ends.

A method 300 for use of the personal information system 100 is shown FIG. 5C as starting with a coach or expert being registered (step 302) with the coach system 128. The coach submits email addresses (step 304) of the coach's team members to be stored in the user data 132. The coach system 128 sends questions to the team members (step 306) including both coach-initiated questions and sent to the coach system through one of the expert workstations 116 and sends other question automatically generated by the system coach system. The team members then use the user workstations 114 to submit answers (step 308) to the data system 110. The coach using one of the expert workstations 116 and the coach system 128 independently review team member answers (step 310). The coach and/or the coach system 128 then generate new questions and messages based upon team member answers to be sent by the coach system 128 to the team members (step 312) and the method 300 ends.

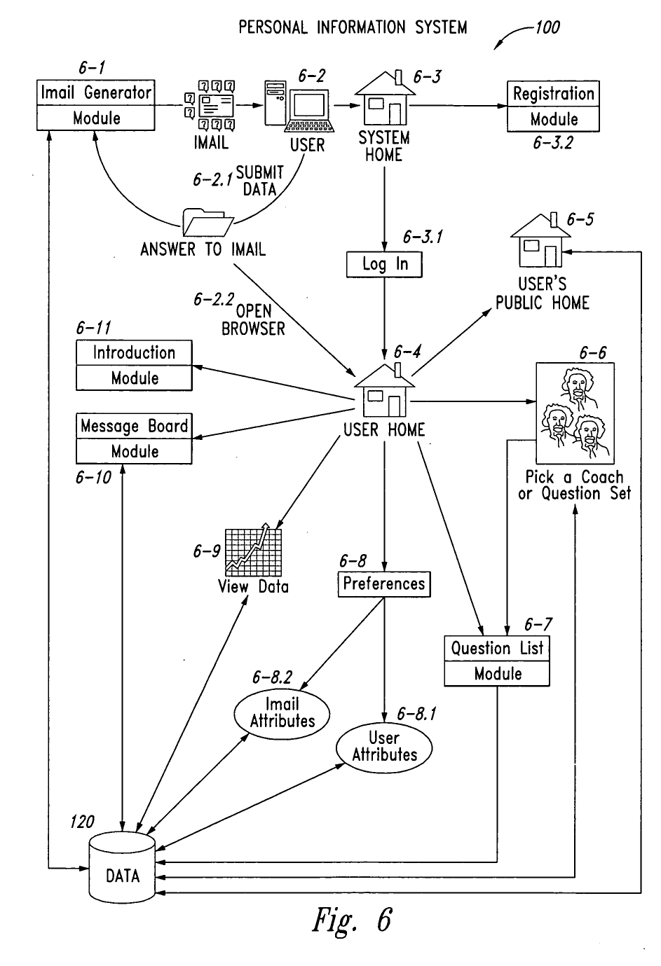

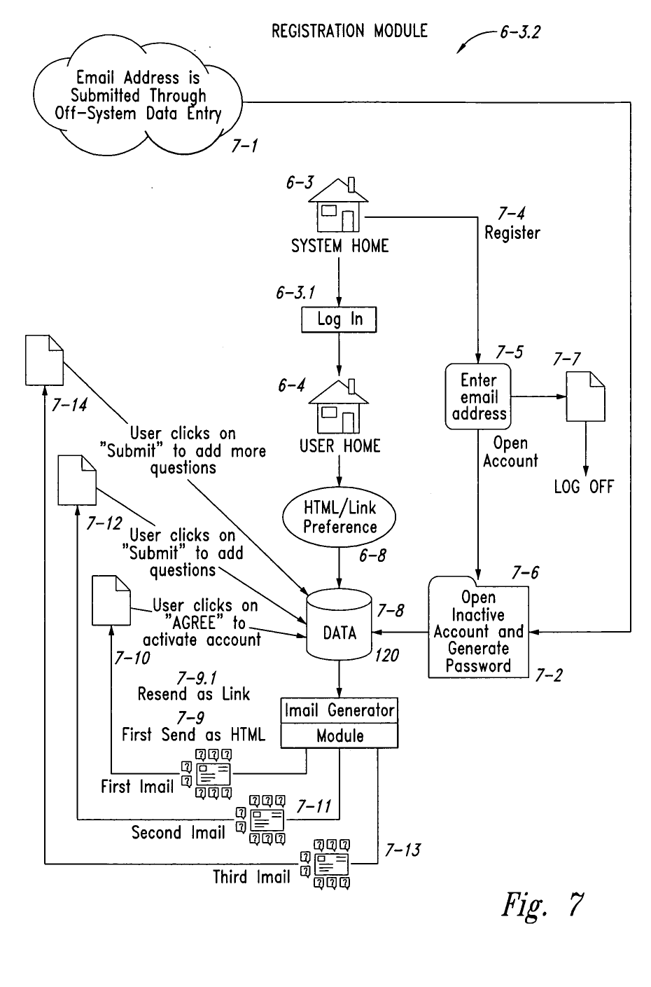

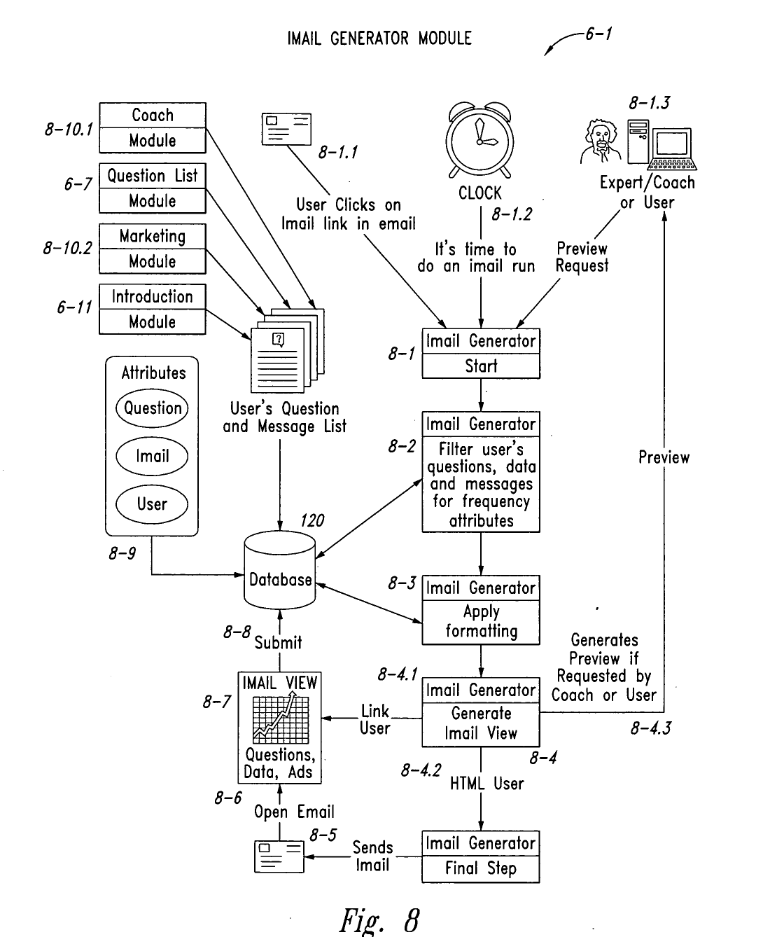

Depicted in FIG. 6 is an exemplary implementation of the personal information system 100 and the data system 110 including an imail generator 6-1. The imail generator 6-1 generates a message with survey questions and additional information (called an “imail”), which the data system 110 sends to a user 6-2. The imail includes questions and messages added to the user's question and message list. The user 6-2, the personal data system 110, or one or more third party experts or coaches can add questions and messages to the users' question and message list, using one of four modules: a question list module 6-7, a introduction module 6-11, or a marketing module 8-10.2 and coach module 8-10.1 discussed below.

As to the user 6-2, there are two ways for the user 6-2 to access a system home page 6-3. The user 6-2 can enter the universal resource locator (URL) of the system home page 6-3 into the user's browser, which opens the system home page 6-3. Alternatively, the user 6-2 can click on a “submit” button in an imail, which launches a browser window that opens to a user home page 6-4 on the system 100. The user 6-2 could also access the user home page 6-4 by entering the URL of the user home page 6-4. The system home page 6-3 provides these options: log in 6-3.1 and registration 6-3.2.

The user home page 6-4 provides options 6-5 through 6-11 as described below:

As to a user public home, the data system 110 provides each of the users 6-2 with a public home page 6-5, on which the user 6-2 can display personal data of the user's choosing, including diary entries, photographs, and personal record keeping reports.

To pick an expert/coach or a question set, the data system 110 will provide the user 6-2 with the option of choosing a set of predefined questions, e.g. a list of questions designed either by the administrator of the data system 110 or by a third party coach or expert. The question can be organized or grouped according to user interest, e.g. there could be a set of questions for people who express an interest in losing weight, or stopping smoking. If the user 6-2 clicks on a check box next to a set of questions, that set will be added to the user's question list. The question list module 6-7 allows the user 6-2 to create the user's own questions and add them to the user's question list. Regarding preferences, the user 6-2 can set a number of preferences. The preferences are in two general areas: imail attributes 6-8.2 and user attributes 6-8.1.

As to view data 6-9, the user 6-2 can view data held in the user's personal portion of the database 6-12. The user 6-2 can see answers to previous imail questions presented in a variety of graphical formats. The user 6-2 can delete data from the user's personal portion of the user database 120 from this screen. Data can be displayed/organized in various ways chosen by the user 6-2. The message board module 6-10 allows the data system 110 to provide message boards for the users 6-2. The introduction module 6-11 matches the user 6-2 with other users based on the user's preferences and profiles. The user 6-2 can view a list of links to user homes whose data matches the user's.

As to the personal portion of the user database 120, this is the database on the data system 110 that contains all the information in the user database 120 held on the user 6-2. All data has data attributes, including security settings, graph types, etc.

The registration module 6-3.2 is further depicted in FIG. 7. Regarding e-mail addresses submitted 7-1 to the data system 110, the user 6-2 need not log on to the data system in order to register. All a user 6-2 needs to do is to provide an e-mail address to the data system 110, because (1) all required registration information can be elicited through imails 7-9, 7-11, 7-13, and (2) the user can fully participate in the data system 110 through subsequent imails.

As to open user 6-2 account and generate password 7-2, once the data system 110 has a potential new user's e-mail address, the data system opens an “inactive” account and creates a password for the user 6-2. With an “inactive” account, the user 6-2 can only change user preferences for HTML or Link 7-17.

A potential new user 6-2 can register by logging onto the system home 6-3. To register, the potential new user 6-2 then clicks on “register” 74. The potential new user 6-2 then enters an e-mail address 7-5. Once the data system 110 has a potential new user's e-mail address 7-5, the data system 110 opens an “inactive” account and creates a user password 7-6.

After online entry of an e-mail address 7-5, the data system 110 presents a message page to the user 6-2 and invites the user 6-2 to log off 7-7. After the data system 110 generates a new account, the data system stores the account 7-8 as user database records inactive account.

A first imail 7-9 to the potential new user 6-2 performs two functions: one, if the user 6-2 finds it in his e-mail inbox, it shows the user can receive e-mails with embedded HTML code. Two, the user 6-2 can accept the terms of use of the data system 110. As to first imail sent as link 7-9.1, if the user 6-2 cannot find the first imail, it could be because the user's e-mail client has sequestered the imail because of the embedded HTML code in the imail. If the user 6-2 changes the imail preference to “link” 7-17, the data system 110 will resend the first imail 7-9 as an e-mail with a link to the first imail display.

As to user agreement 7-10, the user 6-2 clicks on “Agree” indicating acceptance of terms of use. The data system 110 “activates” the new user's 6-2 account, which means the user 6-2 can add questions and receive system services. Regarding a second imail 7-11, the data system 110 sends the user 6-2 a second imail 7-11, with questions designed to add questions to the user's question list. As to user answers 7-12, the data system 110 adds questions to the user's question list. Regarding a third imail 7-13, the data system 110 sends the user 6-2 a third imail, with more questions designed to add questions to the user's question list. As to user answers 7-14, the data system 110 adds more questions to the user's question list.

Regarding log in 6.31, the user 6-2 with an inactive account can log onto the data system 110. As to the user home page 6-4, at the user home page, the user 6-2 can go to preferences 6-8 and then imail preferences 6-8.1 or imail attributes 6-8.2 of FIG. 6. Regarding the imail preferences 6-8, the user 6-2 can change preferences form “link” to “embedded”. The user 6-2 can then click 7-9.1 on link that generates the first imail.

The imail generator module 6-1 is further depicted in FIG. 8. An imail is an e-mail (or other form of electronic communication) that contains survey-type questions (and other information). The user 6-2 answers an imail by filling out the questions in the imail and clicking on a “submit” button in the imail. When this occurs, the user's e-mail client opens and the user's answers are submitted to the user's portion of the database 120. As to start 8-1, there are three different ways to trigger the imail generator 6-1 to generate an imail. As a first way, the user 6-2 clicks on imail link in e-mail 8-1.1. Some of the users 6-2 will set their imail preferences 7-17 to “link”. This means that the data system 110 will send a link to the user 6-2 rather than sending the survey in HTML code embedded in an e-mail to the user 6-2. If the user 6-2 clicks on this link, the e-mail client launches the user's browser and the browser opens to the imail view 8-7 (after going through the steps needed to dynamically generate the imail view). A second way to trigger is with a clock 8-1.2. The imail generator 6-1 can be set to fire off imails once a day or at multiple times during the day. A coach/expert or user initiation 8-1.3 is a third way to trigger an imail. A coach or the user 6-2 may wish to see what an imail will look like. An expert or the user 6-2 accesses the “imail preview” function at 8-12 of the question list module 6-7.

As to filtering user's questions, data and messages for frequency attributes 8-2, each question and message has many attributes, including a “frequency” attribute. That is, a question may be sent at a particular time: one time only, or every day, or once a month on the second Monday, or in the next imail, etc. Or, the question could be sent based on the imail number for this user 6-2. For example, a question could be sent every “nth” imail. Or, a question could be sent if some condition has been met. For example, one question could be sent only if the user 6-2 has responded to a particular previous question. Or, a question could be sent only if the response to a particular previous question was the “correct” response. Or, a questions could include an answer from a particular prior question. Or, a question could be sent over and over until it is answered. The module will select only questions and messages where the frequency attribute is satisfied. Regarding apply formatting 8-3, the user 6-2 can choose how the imail displays questions, messages, and data. Based on preferences set by the user 6-2, the imail generator 6-1 formats an imail using the questions and messages selected at 8-2.

As to generate imail view 8-4, the imail generator 6-1 generates a view of the imail for three presentations. A first presentation is for a link user 8-4.1, who is one of the users 6-2 who prefers not to receive embedded HTML code in the user's e-mails from the data system 110. A link user 8-4.1 clicks on the imail link in an e-mail, and the imail generator 6-1 generates a view of the user's questions, messages, and data.

A second presentation is for an HTML user 8-4.2, who is the user 6-2 who prefers to receive embedded HTML code in the user's e-mails from the data system 110. The imail generator 6-1 sends an imail (with embedded HTML survey and data) to the HTML user 8-4.2.

A third presentation is for a preview 8-4.3. The module can produce a preview 8-4.3 of the imail. The user 6-2 can call for the preview 8-4.3 from within the question list module 6-7. A coach or expert can request the preview from within the coach module 8-10.1.

As to send e-mail 8-5, for HTML users 8-4.2, the data system 110 generates an imail and electronically sends it to the user. Regarding open mail 8-6, upon receiving the imail, the user 6-2 opens it with the user's e-mail client and views the questions, data and messages for the imail created on this run of the imail generator module 6-1. As to Imail view 8-7, whether the link user 8-4.1 clicks on the link in the link user's e-mail, or whether the HTML user 8-4.2 opens an imail with the user's e-mail client, the user 6-2 sees the same view of questions, messages and data.

Regarding submit 8-8, after viewing this run's questions data and messages, the user 6-2 clicks “submit” and the new data provided by the user is added to the user's 6-2 personal portion of the user database 120. As to attributes 8-9, attributes are values that can be adjusted by the user 6-2, a coach or expert, or an administrator of the data system 110. The imail generator 6-1 scans the attributes of each question or message selected for the imail based on the attributes of the question or message.

Regarding question attributes 8-9.1, there are many question attributes. In addition to the frequency attribute 8-2 above, question attributes 8-9.1 include question type, answer type, question text and many others. Question attributes 8-9.1 are set or edited within the question list module 6-7. As to user attributes 8-9.2, there are many user attributes. For example, if a user's preference is to participate in the introduction program but not receive messages or information from or about matched users in an imail, the data system 110 would not send introduction messages and information to the user 6-2. The user 6-2 could not access this data without logging on the data system 110 and going to the user home page 6-4, and then going to the introduction module 6-11. User 6-2 attributes (including introduction and marketing attributes), are set in the user attribute page on the user home 64.

Regarding imail attributes 8-9.3, there can be any number of imail attributes. For example, if the user 6-2 is going on vacation and doesn't want to receive any messages from the data system 110 for the duration of the vacation, the user 6-2 could set his imail attribute to “inactive.” Imail attributes are set in the imail attribute page on the user home page 6-4.

As to a user's question and message list 8-10, the user question and message list contains all the user's questions and messages. The user question and message list 8-10 is created by the user 6-2, the user's coaches or experts, or a system administrator, using one or more modules of the data system 110 including the question list module 6-7, the introduction module 6-11 and the coach module 8-10.1.

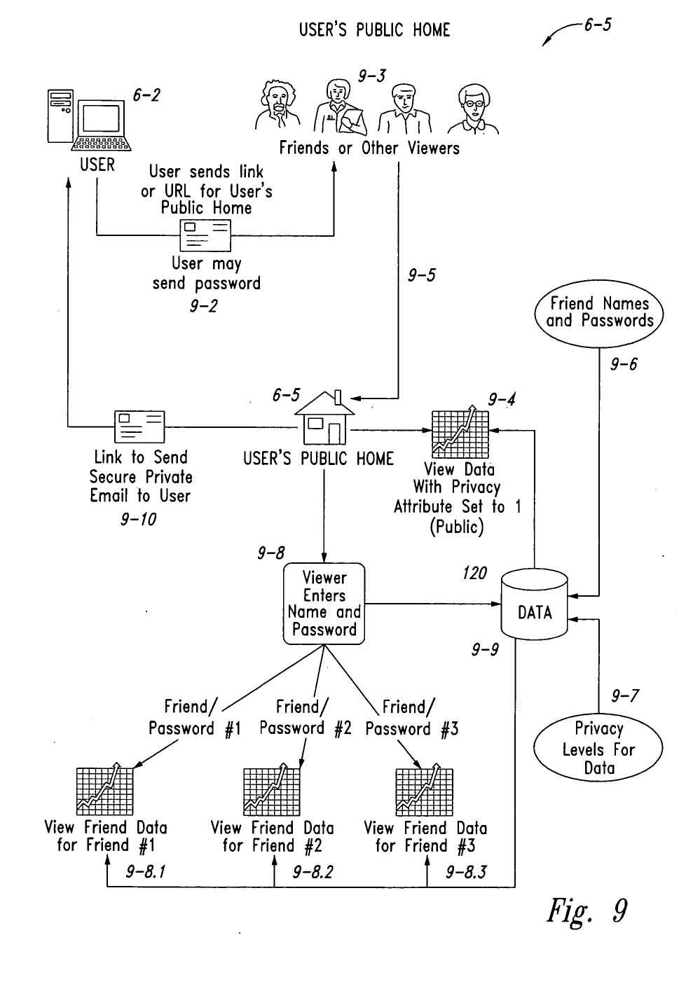

The user public home 6-5 is further depicted in FIG. 9. The user public home 6-5 is a dynamically generated web page that shows data held in the user's personal portion of the user database 120 that the user 6-2 has designated as public data. The user's public home 6-5 is also the access point for the user's friends, family and advisors to view the user's semi-private data (data that the user 6-2 is willing to share with some, but not all, people).

As to the user 6-2, the user is in control of what is displayed (if anything) on the user's public home 6-5. Regarding send link (and perhaps password) 9-2, the user 6-2 can promote the user's public home 6-5 by sending a link or URL to the public home to others. If the user 6-2 wishes another person to have access to data that the user does not wish to share with everyone, the user can also send a password 9-2 to the other person.

As to friends or other viewers 9-3, the user 6-2 can promote the user's public home 6-5 to anyone. A URL of the user's public home 6-5 or link could be posted on a public message board, included in an e-mail, or even provided in advertising. Regarding the user's public home 6-5, this is a home page for the user 6-2, with a unique URL, which can be somehow associated with the user. Viewers access the user's public home 6-5 just like a viewer would access any other web page.

As to view data with privacy attribute set to 1 (public) 9-4, the user 6-2 can choose to make public any data in the user's portion of the user database 120. The user 6-2 sets the privacy attribute while creating or editing a question using the question list module 6-7. Regarding friend name and passwords 9-6, the user 6-2 can add the names of friends, family or advisors to a list of people who have access to certain data. The user 6-2 inputs these names by modifying user preferences on the user home 64.

As to privacy levels for data 9-7, the user 6-2 can designate any single datum or set of data (i.e. answers to a repeated question) as semi-private. Each semi-private piece of data can be associated with a friend's name and password. A viewer of the user's public home 6-5 will only see semi-private data if the viewer has entered 9-8 a name and password that is associated with the data.

Regarding viewer enters name and password 9-8, if a viewer has been designated by the user 6-2 as entitled to view a particular datum or data, the viewer can enter the password and have access to the data. The user 6-2 can designate one password for all the user's semi-private data, and give the same password to a number of friends, who would all then be able to view the same semi-private data. Or, the user 6-2 can designate a piece of data for only one friend. As depicted in FIG. 9, viewer enters names and passwords 9-8 for friend 1, friend 2, and friend 3 and can then view data for friend 1, 9-8.1, friend 2, 9-8.2, and friend 3, 9-8.3.

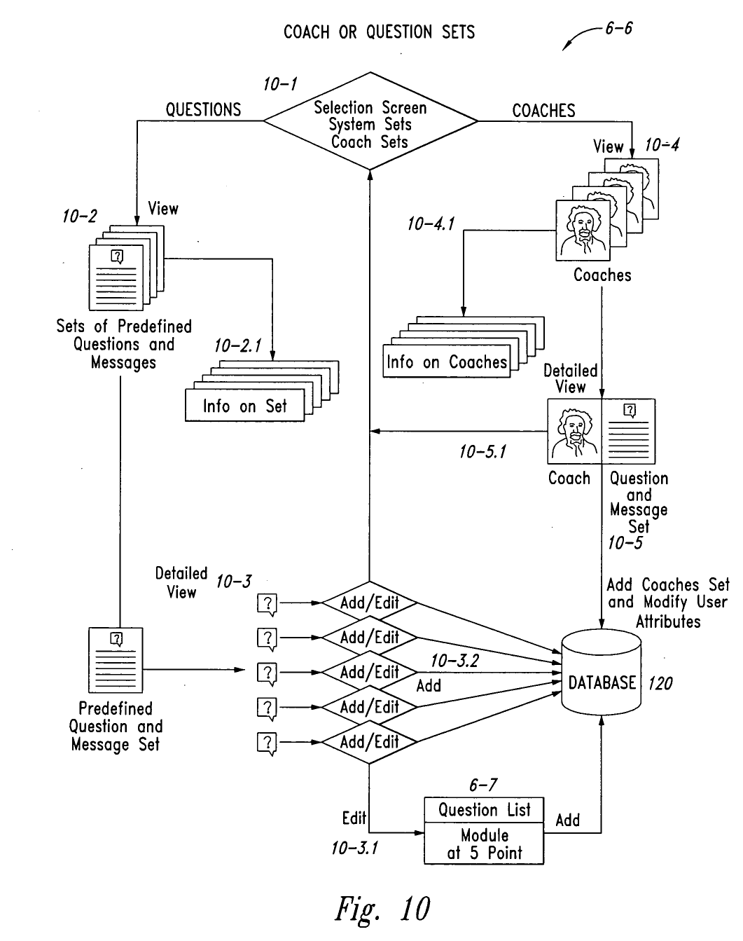

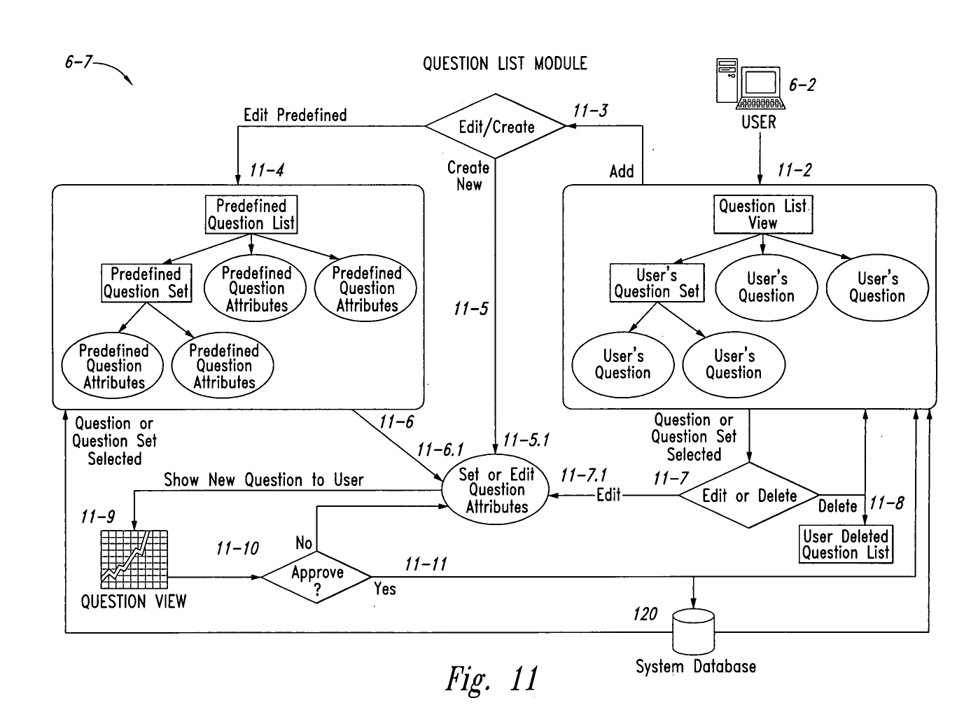

Pick a coach/expert or question set 6-6 is further depicted in FIG. 10. By choosing the “pick a coach or question set” 6-6 link from the user's home page 6-4, the user 6-2 can choose a set of predefined questions created by the data system 110. The user 6-2 can edit the system-supplied question by using the question list module 6-7. The user 6-2 cannot edit the questions supplied by a coach or expert. As to a selection screen 10-1, the user 6-2 can choose whether to select a system question set, or coach's question set.

Regarding predefined question and messages sets 10-2, the data system 110 displays question sets, that is, groups of related questions. Each set can have a theme. The theme could be very narrow and include only a few questions, e.g. “tracking restaurant eating”, or very broad, e.g. “master question list for fitness and health.” As to info on set 10-2.1, the user 6-2 views the available question sets, and can learn a little information about each question set.

Regarding detailed view 10-3, after the user 6-2 chooses a particular question set, the data system 110 displays each questions with two check boxes —“add” and “edit.” If the user 6-2 clicks the “add” box 10-3.2, the data system 110 will add the question to the user's question list unchanged. If the user 6-2 clicks on the “edit” box 10-3.1, the user 6-2 can use the question list module 6-7 to edit and then add the question. If the user 6-2 does not click either box, that question will not be added to the user's question list. After the user selects a question set, the system returns 10-5.1 the user to the selection screen 10-1.

As to a coach and coach's question and message set 10-4, the data system 110 displays a list of coaches or experts. After the user 6-2 chooses a particular coach or expert, the data system 110 displays information on each coach or expert. Next to each coach or expert is check box—“add this coach's questions to user's question list.”

Regarding info on coaches or experts 10-4.1, the user 6-2 views the available coaches, and can learn a little information about each coach or expert. As to add 10-5, if the user 6-2 clicks the “add” box, the data system 110 will add the coach's question to the user's question list. There is no opportunity for the user 6-2 to modify the coaches question and message set. After the user selects a coach or expert, the system returns 10-5.1 the user to the selection screen 10-1.

Regarding database 120, the user's personal portion of the database includes all the questions and the coaches or experts selected by the user 6-2. The question list module 6-7 is further elaborated in FIG. 11. The question list module 6-7 is a tool that allows anyone who wants to build a question to do so. The question list module 6-7 also allows the user 6-2 to edit and delete questions that are added to the user's question list.

As to view question list 11-2, the user 6-2 is presented with a view of all the questions and question sets that are in the user's 6-2 existing question list. Once the user 6-2 has selected a question or a question set, the data system 110 allows the user 6-2 to delete or edit 11-7. Regarding add, edit, create 11-3, when the user 6-2 wishes to add a question to the user's question list, the user is first presented with three options: edit a pre-existing question or question set to the list, or create a question from scratch and add that question to the user's question list.

As to edit predefined 11-4, the user 6-2 is presented with a view of all the questions and question sets that are in the system's library of questions and question sets. Regarding create new 11-5, if the user 6-2 wishes to create a question from scratch, the data system 110 presents the user 6-2 with a question builder screen 11-5.1. All question attributes are shown, with no values entered for any attribute. On the screen 11-5.1, the user 6-2 can provide values for the question's attribute, e.g. question text, question type, privacy level, etc.

As to set or edit question attributes 11-6, once the user 6-2 has selected a predefined question for inclusion into the user's question list, the data system 110 presents the user 6-2 with a screen 11-6.1 that shows all the attributes of the selected questions. The user 6-2 can edit (change) any question attribute.

Regarding delete or edit 11-7, the user 6-2 is offered the choice of deleting a question or editing it. As to user's deleted question list 11-8, deleting a question from a user's question list does not delete the data that was associated with that question from the user's personal portion of the user database 120. The user 6-2 can delete data from the user's personal portion of the user database 120 at the view data screen on the user home page 6-4. All deleted questions are included on the user's deleted question list 11-8, until the data associated with the question is deleted.

Regarding question view 11-9, before adding a question to the user's question list, the user 6-2 first views the question. As to approve 11-10, if the question is acceptable, the user 6-2 can add it to the question list. If the user 6-2 wishes to edit the question, the user 6-2 is returned to the question attribute screen 11-6.1. Regarding user's question list 11-11, if the user 6-2 approves the question, the question is added to the user's list of questions in the user's personal database 6-12.

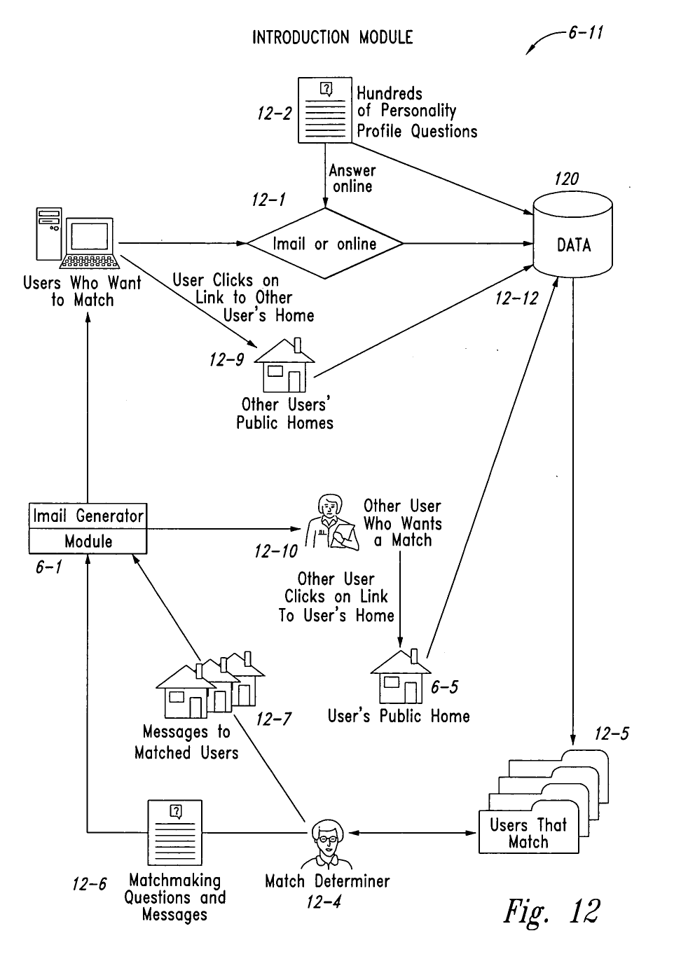

The introduction module 6-11 is further depicted in FIG. 12. As to user who wants to match 12-1, if a user's introduction attribute is set to “want to match”, the match module 6-11 will apply to this user 6-2. The user 6-2 is presented with the option to either participate in creating a profile online, or through imails.

Regarding profile questions 12-2, introduction profile questions can be accessed online, and filled out at once. Or, the data system 110 can obtain all information relevant to the introduction module 6-11 by assigning introduction questions to the user's question list, e.g. “do you want to participate in the introduction program”; “what geographic area would you like find people in?,” etc. After filling out the questions online, the data is included in the user's personal portion of the user database 120. All the user's introduction data and attributes are stored in the user's personal portion of the user database 120.

As to match determiner 124, the match determiner is a computer program that assigns profile questions to the user 6-2, and then cross-filters the user and other users according to the data each enters in their personal portions of the user databases 120, and according to each user's introduction attributes. Regarding users that match 12-5, based on the match determiner program 12-4, the data system 110 will generate a list of other users that match the user 6-2.

As to introduction questions and messages 12-6, the match determiner program 12-4 can generate questions for the user 6-2, based on what the match determiner program determines is needed data to help produce a match. These are the same questions as the user 6-2 could answer online at 12-2.

Regarding messages to matched users 12-7, once the match determiner program 12-4 determines that one of the users 6-2 is a match for another user, the match determiner program can send information to the user about the other user. For example, the match determiner program 12-4 could send the user 6-2 a link to a matched other user's public home 12-9.

As to the imail generator module 6-1, the imail generator module 6-1 will send introduction questions and messages 12-6 to the user 6-2 in the user's imails. Regarding other user's public homes 12-9, if the imail generator has sent a link to the public home of another user, the user 6-2 can click on that link and visit the other user's public home. Once on the other user's public home 12-9, the user 6-2 can send the other user a message 12-10.

As to other users who want matches 12-10, in addition to sending information about other users to the user 6-2, the match determiner program 124 will simultaneously be sending data to other users about the user. Regarding the user's public home 6-5, if the match determiner program 12-4 has sent the other user a link to the user home 64, the other user can visit the user home, and perhaps send a message to the user.

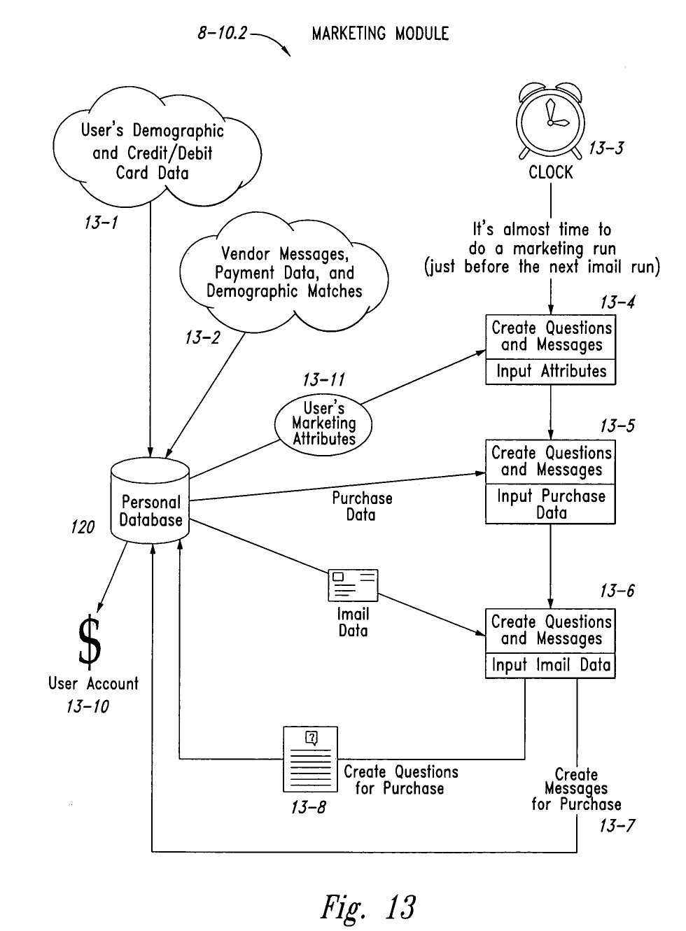

The marketing module 8-10.2 is further depicted in FIG. 13. As to a user's credit/debit card data 13-1, if the user 6-2 has agreed to allow the data system 110 to download to the user's personal portion of the user database 120 the user's credit card and debit card purchasing information, then the most recent data is downloaded to the user's personal portion of the user database 120 on a daily basis.

Regarding vendor messages and demographics 13-2, the data system 110 will arrange with vendors to create a library of vendor messages. Vendors can also provide the data system 110 with the kinds of people that the vendor is most interested in presenting marketing messages to. For example, vendors of expensive cars are only interested in presenting marketing messages to people whose annual income is a certain level.

As to a clock 13-3, periodically (e.g. once a day) the marketing module 8-10.2 will initiate a run to generate questions and messages. Regarding input attributes 13-4, the data system 110 will review user's marketing attributes, e.g. does the user agree to view marketing messages? As to input purchasing data 13-5, if the user 6-2 has agreed to allow the data system 110 to download to the user's personal portion of the user database 120 the user's credit card and debit card purchasing information, then the most recent data is reviewed by the marketing module 8-10.2.

Regarding input imail data 13-6, the user 6-2 may have answered prior questions sent from the marketing module 8-10.2 through the imail generator module 6-1 to the user 6-2. If so, the marketing module 8-10.2 reviews the user's responses to previous marketing questions. As to create messages 13-7, based on the data input into the data system 110, the marketing module 8-10.2 selects messages from the existing list of available messages and targets the messages to the users 6-2 who match the vendors demographic criteria.

Regarding create questions 13-8, based on the available data, the marketing module 8-10.2 generates questions for inclusion in the user's question list in the user's personal portion of the user database 120. For example, the marketing module 8-10.2 may pose a question needed to develop the demographic data needed for a particular vendor.

As to the user database 120, the user's personal portion of the user database 120 will retain information about all marketing messages sent to the user 6-2. Any financial credits earned by the user 6-2 in viewing ads in imails or purchasing related goods and services are stored in a user account 13-10.

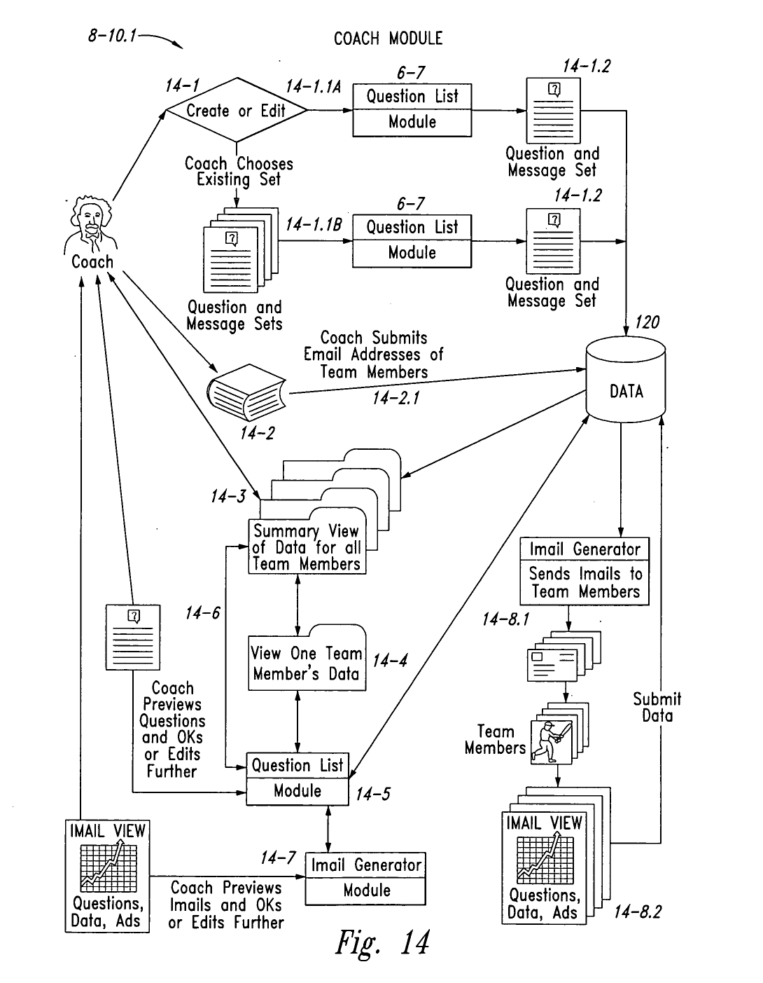

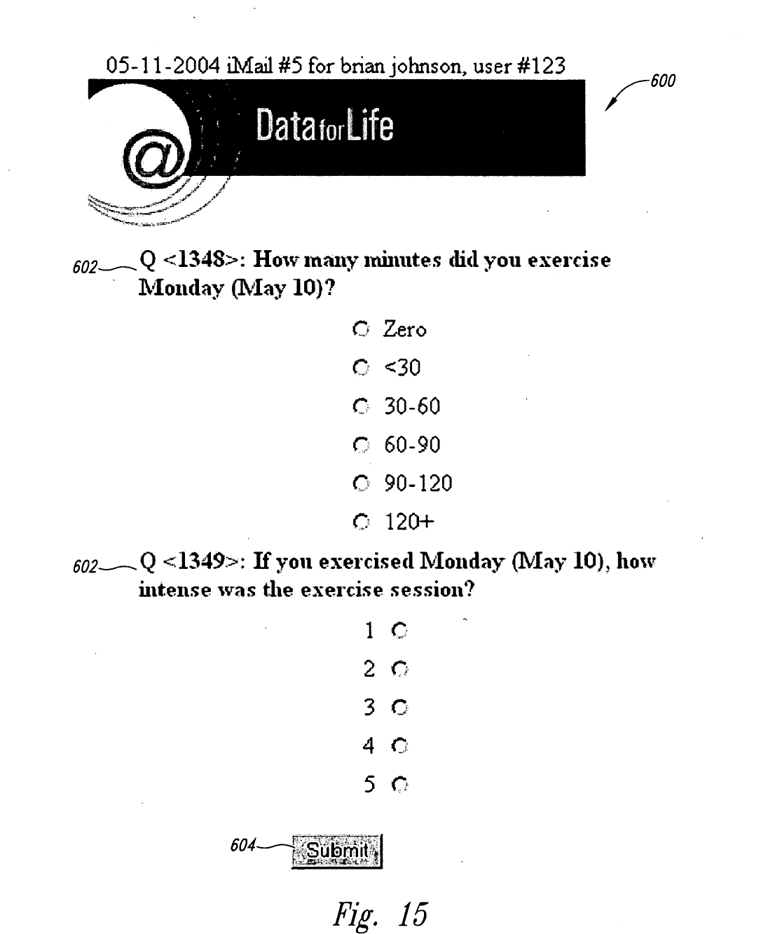

The coach module 8-10.1 is further depicted in FIG. 14. A coach or expert is a third party who can provide questions and messages to one of the users 6-2. As to create or edit 14-1, before a coach or expert can provide questions and messages to one of the users 6-2, the coach must first create a question and message set. The coach can start from scratch 14-1.1A., and use the question list module 6-7 to create a question and message set that is stored in the coach's user database 120. Another way for a coach or expert to create a question and message set is to modify the questions set of another coach 14-1.1B, and use the question list module 6-7 to create a set that is unique to this coach or expert.

Regarding submitting e-mail addresses 14-21, a coach or expert needs team members or other groups of the users 6-2 in order to be a coach or expert. Team members are those users 6-2 who will receive questions and messages from the coach or expert. The coach or expert creates a team or other group by providing the data system 110 with each team member's e-mail addresses (and whatever additional data the coach finds necessary). Or, a user may select a coach from the Select a Coach or Question Set link 6-6 from the User Home page 6-4.

As to coach views data on each team member 14-3, the coach or expert will have access to some of the personal data of each of the coach's team members. The coach gets access to a user's data that is associated with the coach's questions, unless the user blocks access. Also, one of the users 6-2 can permit the coach to access other parts of the user's data, by designating the coach as a “friend” entitled to see the user's semi-private data.

Regarding view one team member's data 14-4, a coach or expert is presented with a detailed view of a team member's data. As to the question list module 6-7, if, after viewing a team member's data, the coach wants to modify a question or a message, the coach or expert can use the question list module 6-7 to modify the team member's imail to include personalized messages and questions for the team member 14-5. Alternatively, the coach or expert may decide to modify the coach or expert's question set, so all team members will receive the new questions or messages generated by the coach 14-6.

Regarding the imail generator preview 14-7, the coach or expert can preview a team member's future imails. As to the imail generator 6-1, the imail generator sends each team member the coach's questions and messages. The team member answers the questions and data is stored in the user's personal portion of the user database 120.

Imail attributes include many aspects. As to fonts, the user 6-2 can choose the font of the e-mail sent to the user 6-2. Regarding colors, the user 6-2 can choose the colors of the e-mail sent to the user 6-2. As to themes, the user 6-2 can choose the themes of the e-mail sent to the user 6-2. Regarding marketing messages OK? (y/n), the user 6-2 can choose whether to receive targeted marketing messages. If the answer is “no,” the marketing module 8-10.2 will not include marketing messages in the user's e-mails.

As to system coaching messages OK? (y/n), the user 6-2 can choose whether to receive coaching messages from the system administrator. If the answer is “no,” the data system 110 will not send coaching messages in the user's e-mails. Regarding introduction messages OK? (y/n), the user 6-2 can choose whether to receive introduction messages from the introduction module 6-11. If the answer is “no” the introduction module 6-11 will not include marketing messages in the user's e-mails.

As to HTML e-mails or e-mails with link to survey?, some users 6-2 may prefer to receive their surveys as embedded HTML in the e-mail sent to the user 6-2. However, some users 6-2 do not wish to receive e-mails with embedded HTML. These users 6-2 can choose to have the imail generator module 6-1 send a “link” to the user 6-2 in the e-mail. The user 6-2 can click on the link, which opens a browser that will open a window onto the user's current questions as determined by the imail generator module 6-1. Regarding active or inactive, if the user 6-2 will not be checking e-mail for a while, the user 6-2 may wish to suspend the delivery of e-mails from the system 100 for a period of time.

User attributes include many aspects. As to user 6-2 has a coach, the user 6-2 can associate with a coach or expert. If the user 6-2 is associated with a coach or expert, the coach's question and message set will be assigned to the user, and the coach will have access to the user's answers to the coach's questions, unless access is blocked by the user.

Regarding user is a coach, some of the users 6-2 are coaches or experts, and thus have access to the coach module 8-10.1. As to associated goals, each of the users 6-2 can declare a long-term goal, e.g. losing weight, making more money, etc. The user 6-2 can associate one or more of the user's long-term goals with any question in the user's question list. Regarding user's level of service, the user 6-2 could pay for the data system 110 through a monthly fee, through targeted marketing, or the user 6-2 could be using only minimal services for free.

Regarding introduction, YIN; this includes online answers on by imail; number of questions per imail. Regarding member attributes, the user 6-2 is either a member or is not a member of a team. Certain features of the data system 110 (e.g. the introduction module 6-11, the marketing module 8-10.2) may only be available to members of a team.

Marketing attributes includes many aspects. Regarding product types, the user 6-2 can designate the kinds of products the user 6-2 does not want to see ads for, e.g. toiletries. As to user permits credit card info to link to database, the user 6-2 can authorize the data system 110 to link with the user's credit or debit card vendor and download the user's purchase information into the user's personal portion of the user database 120. Regarding message types, the user 6-2 can designate what kinds of messages the user 6-2 does not want to see, e.g. banner ads. As to pays a fee, the user 6-2 can opt to pay a fee rather than accept targeted messages.

Introduction attributes includes many aspects. Regarding geography, is the user 6-2 interested in meeting users who live in certain areas? As to key questions for match, the user 6-2 can choose which questions in his question list to seek matches for, and set parameters for the match. For example, the user 6-2 could choose to meet only people whose age is within 5 years of the user's age. Regarding interests, the user 6-2 can choose to match with only those other users 6-2 whose interests are similar. (The data system 110 includes “interest” questions in the registration process).

As to permissions, user permission may be required to display certain data to another user who matches with the user 6-2, and who then seeks data from the other user. For example, the user 6-2 may be willing to provide e-mail address to potential matches, or may require any inquiries from a match to be included in an imail sent by the data system 110 to the user 6-2.

As to seeking whom?, the user 6-2 can set the parameters for a user match even if the user 6-2 does not have data in the user's 6-2 personal portion of the user database 120 that matches another user's 6-2 data, e.g. a male user 6-2 may choose to match only with women. A description of a representative user 6-2 experience of the system 100 can furnish additional exemplary aspects.

As to registration, there are two ways for one of the users 6-2, Joe User, to begin using the personal information system 100— register online, or register by imail. If registration is by imail, in this exemplary scenario Joe fills out a form indicating a desire to meet some goal through personal recordkeeping. The form (including Joe's e-mail address and request to participate) is then transmitted 7-1 to the data system 110. As to opening an account, the data system 110 will open a new “inactive” account 7-2 for Joe, using the e-mail address as username and generating a password for Joe. An “inactive” account allows Joe to log on 6-3.1 and alter his preferences 6-8, but not otherwise access any.

As to the data system 110 sending registration imails, after opening an account for Joe, the data system 110 sends 7-9 Joe an e-mail with embedded survey questions, an “imail.” As to the first imail 7-9, the first imail reads:
This is your username [e-mail address]
This is your password [system generated password]
You must agree to the terms of use for dataForLife. Please review these terms, and, if you agree, click on “agree” at the bottom of the page.
[text of terms of use]
[AGREE] [DON'T AGREE]
Note: This e-mail contains “embedded” HTML code. The default setting is for dataForLife to send you e-mails with embedded code. If you don't want to receive e-mail with embedded code, log onto www.dataforlife.com, enter your username and password, click on ‘preferences,’ and change your preference from ‘embedded HTML’ to ‘e-mail with link to survey.’

If the data system 110 does not receive a response to the first imail, it may be because the embedded code in the imail caused Joe's “spam” filter to sequester Joe's imail. To deal with this problem, if the data system 110 receives no response from Joe within a specified time, e.g. 4 days, the data system automatically changes Joe's “imail attribute” from “embedded code” to “link.” The data system 110 then resends the first imail with a link 7-9.1 to the survey question. Whether Joe responds to the “embedded” or the “link” imail, once the data system 110 receives a record of Joe's agreement to the data system's terms of use, the data system activates Joe's account. With an active account, Joe can log onto the data system 110, log in 6-3.1, access Joe's home page 6-4, and access features on Joe home page.

As to a second imail 7-11, in addition to activating the account, the data system 110 will send Joe his second imail, either embedded or linked, depending on Joe's imail preference. Joe's second imail 7-11 reads:
We received your agreement to our terms of use. Please provide this additional
registration information:
First Name:
Last Name:
How often do you answer your e-mail?
1 Once a day
2 Once a week
3 Weekdays
4 Twice a week
What do you want to do more of, or less of?
More
Exercise
Work
Play
Remember
Emote
Socialize
Less
Eat
Waste Time
Smoke
Use Computer
Drink
Pain
Be Depressed
Click “submit” to enter data.

Joe answered his second imail 7-11 by typing in “Joe User” for his first and last name, “weekdays” for how often he answers his e-mail. He also clicked on “exercise more” and “drink less” in response to the questions “what do I want to more of” and “what do I want to do less of.” After making these entries, he clicks on “submit.” Based on Joe's responses to his second imail 7-11, the data system 110 adds the following two questions to Joe's question list, each with a frequency attribute of “send every week day.”
Q: How many minutes did you exercise yesterday?
Q: How many drinks did you have yesterday?

Joe's question list now has two questions.

As to a third imail 7-13, the data system 110 sends a third imail that contains the two questions about exercise and drinking Joe requested in his second imail 7-11, plus the following question:
What would you like to keep track of?
Daily thoughts Frequency?
Movie Frequency?
Books Frequency?
Music Frequency?
Sports Frequency?
Restaurants Frequency?
Sex Life Frequency?
Projects Frequency?
Family Memories Frequency?
Click “submit” to enter data

Because Joe knows he watches a few movies a week and reads a couple of books a month, Joe sets the frequency for the “books” question at once every two weeks, and the movie question at twice a week. Joe clicks on “submit” and the data system 110 adds the following questions.

Q: Since you last answered this question, what books have you read?
Q: Since you last answered this question, what movies have you seen?

Joe now has four questions in his question list.

Regarding additional imails, even if Joe never logs onto the system's web page, the data system 110 can send questions to Joe that will allow Joe to add and delete questions, change preferences, etc.

As to registration online, although the imail allows one of the users 6-2 to register without ever logging on a system website, the user 6-2 can register online as well. To do so, Jane User (not related to Joe) enters a URL in her browser to open the system home page 6-3. On the system home 6-3, Jane chooses to register 74. The data system 110 presents Jane with a prompt to enter her e-mail address 7-5.

As to the registration screen, Jane sees this prompt on her Registration screen:
Enter E-mail address:
Click on “Open Account” answer is complete.

As to the message screen, upon Jane clicking on “Open Account,” the data system 110 takes Jane to a message page 7-7, which contains the following:
IMPORTANT: Please print out this page and save it for your records. Thank you for completing the first part of the registration process. Your username is your e-mail address and your temporary password is [computer generated password]. Your account is opened, but you can't do anything with your account (yet) except change User Preferences. To activate your account, you will need to answer the question in the e-mail message we just sent you.
Please look for a message with the subject line: “first imail”. To activate your account, you need to open your first imail and answer the question contained in it. If you don't see your first imail in your e-mail client's inbox, check your junk mail folder and check your e-mail settings for filtering and security. Make sure these are set so that you can receive e-mail from dataforlife.com. If you still don't see your “First Imail”, go to www.dataforlife.com, click “log on”, double check your e-mail address for accuracy.
If it is incorrect, correct it. Click on “send First Imail again.” Then, check and see if you can find the First Imail. If the e-mail address is correct and you are still not able to find it, change your preference from ‘embedded HTML’ to ‘e-mail with link to survey.’ Then click on “send first imail again.” When you change your preference to “e-mail with link to survey,” we will resend your First Imail, this time without the embedded code.
Until you answer the question in your First Imail you cannot use the System.

The page also provides a link to log off.

As to opening an Account, when Jane clicks “Open Account,” the data system 110 also opens an “inactive” account for Jane in a system portion of the user database 120, and generates a password 7.8. As soon as a new account is opened, the system 100 will call the imail module FIG. 8 to send Jane her first imail 7-9.

As to looking for the imail, by default, the first imail to Jane will be an “embedded” imail. The imail is identical to the first imail sent to Joe in his registration with the data system 110. As with Joe, because Jane's e-mail client may filter out an “embedded” imail, the data system 110 must make sure Jane can read embedded e-mails. If Jane cannot find her first imail (whether embedded or linked), she obviously cannot agree to the terms of use agreement by clicking on “agree” in the imail. Until Jane agrees to the Terms of Use, Jane's Account is not active (Jane cannot add question to Jane's question list). In this event Jane would need to follow the instructions from the registration message page 7-7. To follow these instruction, Jane would browse to the system home page 6-3, log on 6-3.1, click on the “preferences” link on Jane's home page 6-8.1, and change Jane's preference from “HTML” to “link to imail.” Upon making this change, the data system 110 resends 7-9.1 the first imail to Jane, but the resent first imail does not contain embedded code. Rather, the second version of the first imail includes a link to the display page of the first imail—a page that contains the terms of use and an “agree” button. Upon receiving the agreement to the terms of user, the data system 110 would send Jane a second imail 7-11 with a link to the second imail 7-11 display. After Jane responds to the second imail 7-11, the data system 110 sends Jane a link to her third imail 7-13. Jane responds to the questions in her third imail 7-13, and subsequent imails.

As to question sets, after registering, Joe User decides to add a question set. Joe goes to the system home page 6-3, enters login info 6-3.1, and then clicks on “Pick a question set or coach 6.6” In adding a question set, Joe must make a preliminary decision: either choose to add a question set created by the data system 110, or a question set 10-4 created by a third party coach or expert. If he chooses a system question set 10-2, he can edit the questions. However, if he selects a coach question set 10-4, he cannot edit the coach's questions, and, the coach will have the ability to monitor Joe's responses, and provide additional questions and messages for Joe's imails. However, at any time Joe could “opt out” of being a team member of any coach, and thus deny access the Coach's access to Joe's data.

As to system-designed question sets, the predefined question and message set view 10-2 allows Joe to see a summary listing of the system's question sets available for selection. Each question set has associated information 10-2.1. The available question sets include questions designed for use by people who wish to lose weight, a different set for use by people who wish to keep track of their recreational activities, etc. Each question set could contain a few, or as many as a hundred or more, questions of various frequencies. That is, depending on the question set, some questions will be sent to Joe every day, others will be sent once only, or once a week, etc. Joe decides he wants to keep track of his TV watching. His goal is reduce the amount of time he watches TV, and to improve the quality of the shows that he watches. The “TV Watcher's question set” has the following questions:
Q: How much time did you spend watching TV yesterday?
Q: What show did you watch that you are glad you watched?
Q: What show did you watch that you wished you had done something else?

Although the coach has set the frequency on these questions as “every day,” because Joe earlier stated that he only checked his e-mail on weekdays, the frequency for these questions in Joe's question list will be “weekday.” Now, Joe has seven questions in his question set, four weekday questions, one that is sent to Joe twice a week, and one sent every two weeks.

As to edit system-designed questions, Joe has the opportunity to modify 10-3 each and every question in a system-designed question set. Joe sets the frequency attribute for each of these questions as “weekdays” and adds 10-3.1 all three questions to his question list.

As to coach-designed question set, Joe also decides he would like to engage a coach or expert. The coaches view page 10-4 displays information about each coach and as much about the coach's question set 10-4.1 as the coach wishes to display.

As to the user 6-2 selecting a coach, Joe selects Coach Sally, who offers a service to help people stay on an exercise program using a question and message set 10-5. After Joe adds a coach 10-5, the data system 110 returns Joe 10-5.1 to the selection screen 10-1. Joe can then add another question set or coach, as he wishes.

As to the user 6-2 adding the coach's question set, by selecting Coach Sally, Joe adds Coach Sally's question and message set 10-5 to Joe's question list in his personal database 6-12. Coach Sally's questions are mostly “conditional” questions, that is, subsequent questions depend on variables established by a user's prior responses to a question. Coach Sally's first question is:
Q: What are your favorite forms of exercise?

This question was added to Joe's question list, as a one time question. Because Joe added Coach Sally after his third imail 7-13, her question was sent to Joe in his fourth imail. Joe answered the question by typing in the word “running” in the answer blank. In Joe's fifth imail, Coach Sally's next question is:
Q: On average, how many times do you run a week?

Joe answered: 2. In his sixth imail, Coach Sally's question to Joe is:
Q: On average, how far do you run each time you run?

Joe answered 2 miles. Coach Sally responds in his seventh imail:
Q: How many times would you like to run each week?
Q: How far would you like to run?

Joe answered: 4 and 3, respectively. In his eighth imail, Coach Sally sends the following message and question:
Message: You report that you run an average of 2 times a week for an average of 2 miles. You report that you would like to run 4 times a week, for an average of 3 miles per run. Based on this response, I suggest that this as Personal Goal: “run an average of four times a week, run an average of 12 miles a week.” Accept Goal? y/n
I also suggest that you add the following fixed question to your question list: “Q: How far did you run yesterday?” Accept question? y/n
Finally, I suggest that you allow me to provide you with information, message, questions, and encouragement on a daily basis, based on your responses to my previous questions. Accept question? y/n

Joe answers “yes, yes, and yes”. Each day, Sally sends Joe information, encouragement and additional questions. Later, if Joe achieves his goal, Coach Sally will send messages of congratulations. If Joe fails to achieve his goal, Coach Sally will send messages of encouragement.

As to the data system 110 changes attributes, Joe's action also causes the data system to modify Joe's and Sally's user attributes. For Joe, the data system 110 adds the attribute of “team member to Coach Sally”. For Coach Sally, the data system 110 adds Joe as one of her team members. Also, for each of Joe's questions from Coach Sally, the data system 110 changes the question privacy attribute to allow Coach Sally to view Joe's answers to each of Sally's questions. Based on these attribute settings, the data system 110 allows Coach Sally to view Joe's answers to her questions.

As to the user 6-2 making a coach privy to his data, Joe decides to add Coach Sally as a person authorized to view other data in Joe's personal database 6-12. Joe already has an exercise question in his question list (“How many minutes did you exercise yesterday”). He wants to share his answers to this question with Coach Sally. He also wants to share his answers to the question regarding how much time he spends watching TV because if he's watching TV he's not exercising. Joe adds Coach Sally as an authorized person to see this data by assigning a password to these data and providing that password to Coach Sally.

As to a coach providing advice, by selecting Coach Sally as his coach, Coach Sally has the ability not only to monitor Joe's responses to her questions, she can also provide messages to the Joe in Joe's imail.

As to the coach module 8-10.1, a coach can be any one who wishes to assist another user by reviewing user data. The user 6-2 who is being assisted by a coach is that coach's “team member.” Coach Sally is a personal trainer who provides advice to people who want to become more physically fit. Coach Sally's user attribute includes “coach” as an attribute. As a result, Coach Sally's home page 12-4 includes a link to the coach module 8-10.1. A coach module page allows Coach Sally to (1) create or edit a set of questions that can be displayed through the data system 110, (2) to add team members, and (3) to view team data and provide real-time messages and questions to her team members.

As to creating or editing a question set 14-1, a coach or expert need not design a question set, but she may choose to do so. Coach Sally decided to create a question set. Her first decision is whether to start from scratch 14-1.1A or choose an existing set to edit to her liking 14-1.1B. Whatever she chooses, Coach Sally can set the attributes of each question and message in her question set—that is, she can set the question text, a question message, the question type, the answer type, etc. Once the coach is satisfied with the question set 14-1.2, the data system 110 stores the set in the database 6-12 for later display to users 6-2 on the “question set” page on the user home 6-4.

As to when a coach submits e-mail addresses 14-2, although Coach Sally can be a coach without her own question set, she cannot be a coach without team members. A coach can obtain team members from a website of the data system 110. That is how Joe came to be one of Coach Sally's team members. Or, the coach can introduce a new member to the data system 110 by providing the data system with each team member's e-mail address. Coach Sally, as a personal trainer, already had a number of clients before she became a coach on the data system 110. Because she wants to use the data system 110 to assist her in providing her service to her clients, Coach Sally adds her existing clients' e-mail addresses, as potential team members 14-2.1. One of Coach Sally's existing clients is John, who has an ongoing fitness program that Coach Sally has been helping him with. John goes through the registration process described above. Coach Sally's registration imails are tailored to Coach Sally's unique program. Because Coach Sally knows John's existing goals and his exercise program through her prior association with John, Sally creates a registration question list for John that addresses his unique situation.

As to a summary view of all team members' data, one of the keys to the coaching/team member relationship is the ability of the coach to review the team member's personal data. On Coach Sally's home page, the data system 110 presents a link to a summary view of each of her team members' data. The data includes answers to (a) Coach Sally's questions; and (b) any other data for which the user 6-2 has designated the coach as an authorized viewer. As mentioned above, Joe has designated Coach Sally to view questions that are not part of Coach Sally's question set. John, however, has no questions other than Coach Sally's. The coach's summary view of the team members' data 14-3 is summarized in a customizable manner.

As to viewing one team member's data, if Coach Sally wants to view John's data, she can click on a link associated with John's summary data, and examine John's data in detail. If she wishes to check on Joe's data, she similarly can click on the link for Joe's detailed data 14-4.

As to the question list module 6-7 for one team member, the coach can modify a team member's individual questions and messages 14-5. This allows Coach Sally to add a personalized message to any team member's next imail. For example, after John went for a week without lifting weights, Coach Sally sent John a question in his imail that read as follows:
Q: You haven't lifted weights for a week. Why not?

After modifying a team member's questions or messages, the data system 110 takes the coach back to the summary view 14-6, and stores new question or message in the database 6-12.

As to the question list module 6-7 for all team members, if a coach wishes to provide a message or a question for all team members, the coach can access the question list module 6-7 and edit the questions and messages set for all team members 14-6. After modifying her question set while reviewing her team's data, the data system 110 takes the coach back to the summary view 14-6, and stores new question or message in the user database 120. Coach Sally has a number of fitness and diet tips that she likes to share with her team members. Accordingly, as the summer heats up, Coach Sally modifies her question set to include a message to be sent 14-6 to her team on June 15. Each year, all of Coach Sally's team members will receive the same question on June 15:
Message: When it's hot, be sure to drink lots of water before you exercise!

As to previewing imails, after Coach Sally modifies her questions or messages (either for individual team members or for the entire team), she may want to preview the imails. If the imail is acceptable, the question list generator module 6-7 stores the new questions and messages in the user database 120.

As to the imail generator 6-1 sending imails to team members, the imail generator sends Coach Sally's imails 14-8.1 to her team members, based on her current question set, as edited by Coach Sally. Each team member answers his or her imail, which augments each team members' personal portion of the user database 120. Once the data is submitted, the coach can view the data at the summary view 14-3 or the one member view 14-4.

As to a question list, when Joe User first set up his question list, he included a question that asked what movies he watched. He set he frequency attribute to “twice a week.” Joe realizes after a few weeks that he can answer the question just as well if he receives it once a week rather than twice a week. So, Joe decides to edit the frequency attribute of the question. He goes to the system home page 6-3, enters his login info 6-3.1, and then clicks on “question list” 6-7.

As to the question list view 11-2, the question list view allows Joe to see a summary listing of the questions in Joe's question list.

As to editing, Joe clicks on the question about watching movies in the question list view 11-2. The data system 110 presents Joe with a choice of editing or deleting 11-7 the question. Joe chooses “edit.” The data system 110 takes Joe to the question attribute page for this question 11-7.1. The data system 110 presents Joe with the opportunity to modify any question attribute, but Joe only wants to change the frequency attribute. He changes the frequency from twice a week to once a week (on a Monday), and clicks on “finished.” The data system 110 shows him the question view 11-9. Joe finds the change acceptable, and clicks on “approve” 11-10. The data system 110 takes Joe back to the question list view 11-2.

As to deleting, if Joe had decided he wished to eliminate the movie question from his question list, he could have chosen “delete” rather than “edit” when he clicked on the movie question 11-7. The data system 110 would have then deleted the question from Joe's question list, and the data system 110 returns Joe to the question list view. As to adding, in addition to editing his question about movies, Joe decides to add a question that allows him to write a little “review” of the movie. So, Joe clicks on “add” in the question list view 11-2. The data system 110 presents Joe with a choice either edit a predefined question or create a question from scratch 11-3.

As to starting from scratch, Joe wants to start from scratch 11-5. So, he clicks on “create new” and the data system 110 takes him to the question attribute page 11-5.1 for a new question. On this view, each question attribute is blank, and Joe can select whatever values he chooses for each attribute. In this case, he selects that same frequency attribute as he had selected for his other movie question (once a week on a Monday), so both movie questions will show up in the same imail. He sets the “question text attribute” to “Rank this movie on a scale of one to five, with five being “best.” After setting the question attributes, Joe can preview the new question 11-9, and then either re-edit the question 11-10 or add it to his question list in a system portion of the database 120. After the new question is added, the data system 110 takes Joe back to the question view page 11-2.

As to editing a pre-existing question, Joe also decides to edit an pre-defined question and add that question to his question list. A predefined question is a question designed by the data system 110 and placed on a website of the data system for selection by the user 6-2. To add a predefined question to his question list, Joe clicks on “add” from the question list view 11-2. The data system 110 presents Joe with a choice, and Joe selects “edit predefined” 11-3. The data system 110 presents Joe with a list of predefined questions 11-4. Joe selects the question “How many drinks did you have” 11-6. Joe is presented with a list of questions attributes 11-6.1. Joe changes the question text to “How many glasses of wine did you drink yesterday.” He changes frequency attribute from “daily” to “weekdays”). He changed the answer attribute from “numeric entry” to “multiple choice,” with 6 choices —0, 1, 2, 3, 4, 5 or more. After making these changes, the data system 110 provides Joe with a view of what the question will look like in Joe's imail 11-9. After viewing the question, Joe can continue editing and viewing 11-10. Or, Joe can accept the question 11-11. Upon Joe's acceptance of the question, the data system 110 adds the question to Joe's question list in the system database 6-12, and Joe is returned to the question view 11-2.

As to targeted marketing, Joe learns from reading information provided by the data system 110 that can the system can provide significant benefits to Joe if the data system 110 has access to Joe's demographic data, as well as Joe's credit card and debit card purchase information 13-1. The demographic data needed includes his income, where he lives, what he does for a living, how many kids he has, is he married or divorced, etc. The credit and debit card information needed are Joe's consumer purchase information, downloaded to the data system 110 in “real time” (the night after the purchase). Joe also learns that vendors who advertise on the internet pay “publishers” to place messages where a consumer will see them. Because the targeted marketing module 8-10.2 allows Joe to control what messages appear in Joe's imails, Joe can (in effect) self-publish the messages in his imails. Joe learns that vendors download their ads and demographic matches to the data system 110 on a regular basis 13-2. Finally, Joe learns that the data system 110 will pay Joe a share of each payment that a vendor pays to the data system 110 for placement of a message in one of Joe's imails. He learns that each vendor transmits monthly payments to the data system 110 in a manner that allows the system 100 to identify Joe as the person responsible for generating the revenue from a particular vendor. Thus, the data system 110 can credit Joe's user account 13-10 with Joe's share of all vendor payment attributable to Joe. Joe decides to fully participate in the system's targeted marketing program. To do so, Joe must set his targeted marketing attributes to allow access to Joe's demographic and purchase data. Joe modifies his marketing attributes 6-8.1 and selects the option that is appealing to him.

The marketing attributes include many aspects. As to a consumer goods or services of interest marketing attribute, Joe identifies those consumer items that are of interest to him. The marketing module 8-10.2 uses Joe's expression of interest to assign messages to Joe's message list. The message is assigned if the message's attribute for “item type” matches Joe's stated interest. Because Joe likes to watch movies and listen to music, Joe chooses “recorded music” “rented movies” as a consumer item of interest. Because he likes to eat out, he also chooses “restaurants.” Joe can enter these “interest” attributes while on line, or by answering marketing questions in his imails.

As to a provide demographic data marketing attribute, Joe provides complete information about himself, because he knows that the more the data system 110 knows, the better the data system will be able to exploit his data for targeted marketing purposes. If Joe fills out an application for a personal information system credit card, and/or provides permission for the data system 110 to access Joe's credit records, the data system can create a robust demographic profile of Joe. The data system 110 can use Joe's demographic profile to help identify which of the thousands of vendor messages would generate the most revenue for Joe and the data system.

As to an approval to input credit card/debit card data marketing attribute, Joe agrees to allow the data system 110 to have access to Joe's credit and debit card purchase information. The data system 110 obtains this data by issuing a credit or debit card to Joe. The data system 110 also has arrangements with other credit and debit card issuers, under which the issuer provides the data system with Joe's credit/debit card purchases. The data system 110 receives Joe's consumption data on at least a daily basis. Joe knows that by agreeing to provide his consumption data, the targeted marketing module 8-10.2 will send messages to Joe that are designed to be attractive to Joe.

As to an approval to provide consumer coaching marketing attribute, Joe decides he could use a coach to assist him with his consumer behavior. By agreeing to receive coaching help, Joe can receive messages from the data system 110 that compares Joe “actual” prices on items he bought with “available” prices that Joe could have through vendors affiliated with the data system 110. And, the Consumer coach can ask questions of Joe about his consumption patterns. Based on Joe's responses to these consumer questions, the marketing module 8-10.2 can time the placement of messages for the period that Joe is ready to buy the item described in the message.

As to message types acceptable marketing attributes, Joe decides to accept all vendor message types, because he knows that if Vendors are willing to pay the data system 110 to put messages in his imails, he will share in the revenue. As to a pay-per-click marketing attribute, when Joe clicks on a pay-per-click message in one of this imails, the vendor who placed the messages records Joe's click, and credits the data system 110 (and Joe) on the vendor's books. The per click payment amount may be included in the message published in Joe's imail.

As to a cash back marketing attribute, Joe clicks on a cash-back message, and then goes on to purchase something on the vendor's web site. Upon completing the purchase, the vendor credits the data system 110 (and Joe) with a rebate of a certain percentage of the purchase price. The amount of the rebate percentage may be published along with the vendor's message in Joe's imail. If Joe does not purchase from the vendor after clicking through on an imail, the vendor would not owe the data system 110 anything.

As to a cash-to-place marketing attribute, some vendors will pay simply for the right to publish a message, even if there is no click or purchase. A placement's value to a vendor is directly related to the sales generated by the placement. A vendor who knows that a particular placement will have a high likelihood of generating a substantial sale may pay a substantial sum. Because of Joe's income and other demographic data, he is a consumer who is of extreme interest to many Vendors.

As to how the marketing module 8-10.2 works, the data system 110 knows (from Joe's marketing attributes 13-11) that Joe likes to buy recorded music. On the 5th of the month, the data system 110 learns 13-1 that Joe has just bought tickets from a ticket vendor. The data system 110 knows that Joe has bought something from a ticket vendor, and it knows the amount of the purchase, but the data available to the data system from credit/debit card data does not include data on the show the ticket is for, the date, or anything else. Accordingly, on the 6th of the month, the data system 110 generates a question 13-8 for Joe's next imail: “You purchased an item from [ticket vendor name] for [amount]. What is the ticket for? (what show are you going to see). On what date?” The next day Joe answers “Chicago, the musical play” and “May 20”. A week or so before the 20th, based on a combination of the credit card data, demographic data, and imail data, the data system 110 sends Joe messages 13-7 from restaurants in the area. The restaurant messages let Joe know that if makes an online reservation and keeps it, the restaurant will pay $10 to the data system 110. A few days before and after the 20th, the data system 110 sends Joe messages 13-7 from vendors of the sound track of “Chicago.” The vendor messages let Joe know that if he buys the soundtrack online, the vendor will pay 10% of the purchase price to the data system 110. Joe knows that the data system 110 will credit his user account 13-10 with a share of the vendor payments to data system 110.

As to how the consumer coach works, from Jane's answers to questions generated by the marketing module 13-10, the data system 110 knows that Jane is a wealthy professional, with a family income well over $125,000 per year. The marketing module 13-10 sends these questions to Joe: “What kind of car do you drive?” “How long have you owned it?” “When do you expect to be in the market to buy a car?” “What kind of car are you interested in purchasing?” “Do you expect to buy new or used?” Based on Jane's answers, and based on Jane's demographics, the data system 110 solicits car vendors for Jane, and effectively “markets” Jane to the car vendors, to sell “message” space in Jane's imails. Jane really hates to see vendor messages (unlike Joe who likes to see them). As a result, Jane has set her marketing attributes to not allow any messages in her imails unless the vendor is willing to pay $20 to the data system 110. The data system 110 identifies a vendor of high-priced cars who agrees to pay $20 to place a message in one of Jane's imails. Jane sees the ad in his imail, and does not click on the link in the ad. At the end of the month, Jane's user account is paid Jane's share of the $20. Since Jane's share of the $20 is greater than the data system's cost to Jane for that month, there is no charge to Jane for the data system's services for that month.

As to introduction, Joe receives an imail question from the data system 110 that asks “Would you like to participate in the system introduction Service? y/n”, Joe answers “yes.” Joe could also access the introduction service by going to the introduction module 6-11. Accepting matching services also changes Joe's user attribute 6-8.1 to indicate participation in introduction. The data system 110 has hundreds of introduction questions 12-2. Joe's answers to these questions will allow the data system 110 introduction module 6-11 to generate a robust personality profile for Joe. Joe could spend hours answering all the questions at once (as is done currently on other introduction services), by logging on the introduction module 6-11, and choosing the option “answer online” 12-1. Or, if Joe chooses to answer the questions online, the data system 110 can send the same questions to Joe over time. The first question 12-6 to be sent to Joe would be “how many introduction questions do you want receive in each imail?” Joe responds “4”. Thereafter the introduction module 6-11 will provide four unanswered profile questions 12-6 to Joe in each of his imails. The frequency attribute for introduction questions is “resend until answered.” Some of Joe's profile questions will bear on the issue of what kind of match Joe is after. The data system 110 generates answers to these questions “Are your looking for a woman to date?” “How far are you willing to go to meet someone who is a match?” After answering a number of profile questions 12-6, the data system 110 can match Joe with the profiles of other users 12-5 in the data system. Once the introduction module 6-11 has made a match, it sends an imail 12-6 to Joe. It also sends a similar imail to the person who is the match, Jane. The message to both Jane and Joe reads “We have a match for you. We have matched this person to you because of these matches between your profiles [age, location, sex, movies liked, music liked, etc.] If you would like to meet this person, go to [link to URL of matched person's public home on the system].” Joe receives the message and clicks on Jane's link 12-9. Jane clicks on Joe's link. Jane and Joe view each other's personal data that each has designated as “public data.” Neither Joe nor Jane, have placed their real names or e-mail addresses on their public pages. However, the data system 110 allows people who view a user's public home page 6-5 to send an internal message to the owner of the public home page. So, Joe sends 12-12 a system message to Jane. Joe's message is included in Jane's next imail. Jane reviews Joes message and answers the accompanying question from the introduction module 6-11 “do you want to respond to this message.” Assume Jane says “no” (because she didn't like what she learned on Joe home page, or because she didn't like his personal message). The data system 110 transmits this rejection to Joe in his next imail. Because of Jane's rejection, the data system 110 will not send further messages from Joe to Jane. Assume Jane says “yes.” The data system 110 prompts Jane for a response message, which the data system 110 would include in Joe's next imail. However, since Joe included his phone number in his imail message, Jane eschewed the response opportunity provided by the data system 110 and chose to call Joe instead.

As to the user's public home 6-5, Joe's public home is where Joe can display his data for the public to see and where he can display password protected data that only Joe's “friends” can see. Joe can provide the URL to his public home by sending a link to his public home in an e-mail. Anyone who knows Joe's URL can access Joe's public home page 6-5. There is no need to enter a password to view Joe's public data. Joe is proud of his movie taste and his movie reviews, so sets the privacy attributes on this data as “public.” Joe wants Coach Sally to have access to all of his physical fitness data. Plus, he wants his doctor to have access to his drinking consumption data. Joe goes to the question list module 6-7 and sets the question attributes for each of his physical fitness questions to include access to anyone with password #1 or password #2. He sets his drinking question to show data to anyone with password #2. Joe provides password #1 to Coach Sally and password #2 to his doctor 9-2. When Coach Sally goes to Joe's public home, she enters password #1, and the data system 110 displays Joe's physical fitness data to her. When Joe's doctor goes to Joe's public home, he enters password #2 and is shown both Joes fitness data and his drinking data.

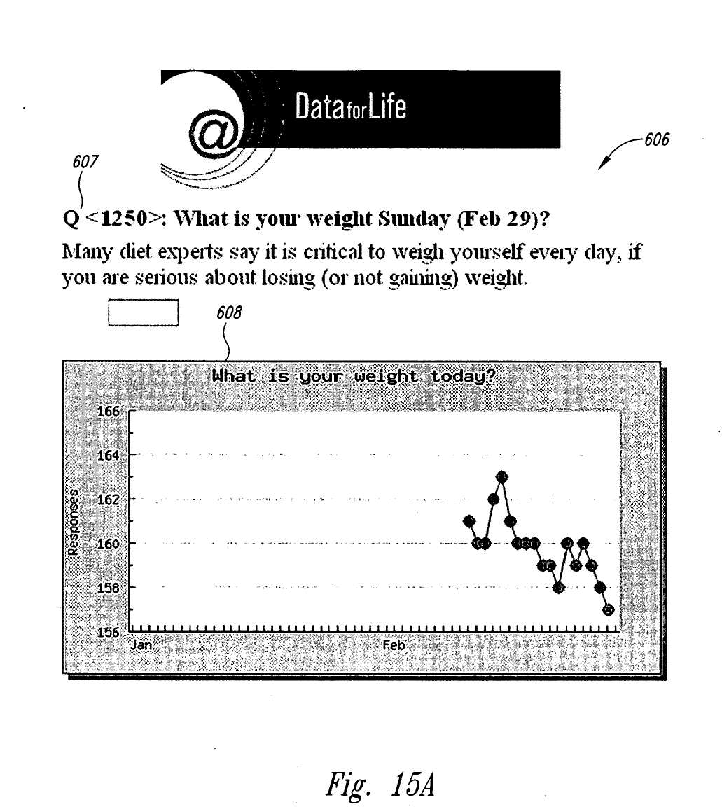

As to FIG. 15, a screenshot shows an exemplary imail 600 having questions 602 to be answered by user and submitted using a submit button 604 contained within the imail to submit answers to an implementation of the personal information system without having to log on to the personal information system. FIG. 15A shows a screenshot of another exemplary imail 606 using a line graph to display historical data previously submitted by the user 6-2 in responses to previous imails.

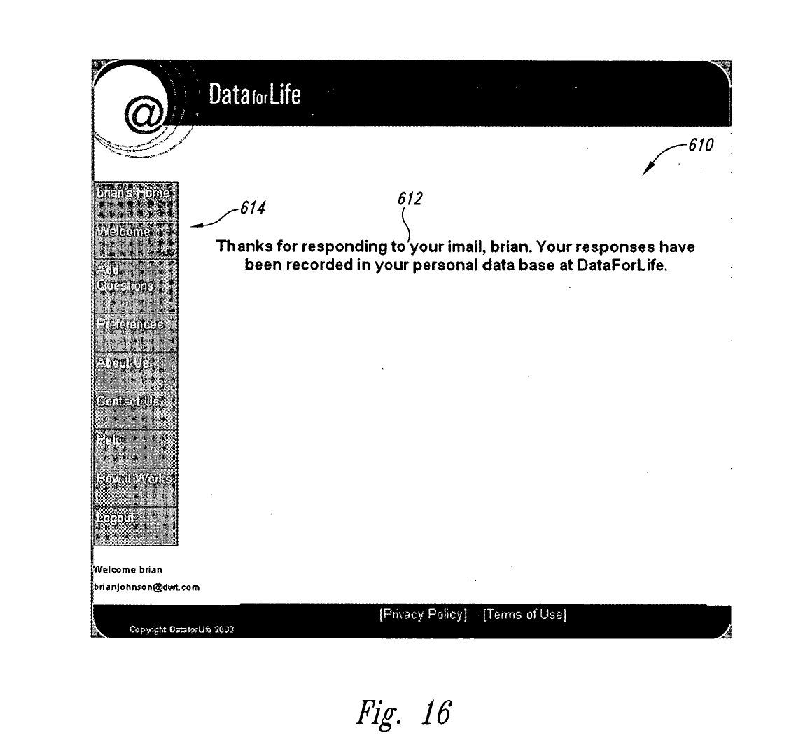

As to FIG. 16, a screenshot shows a response screen 610 having textual information 612 with a main menu 614 being displayed after a user's answers are submitted to the personal information system.

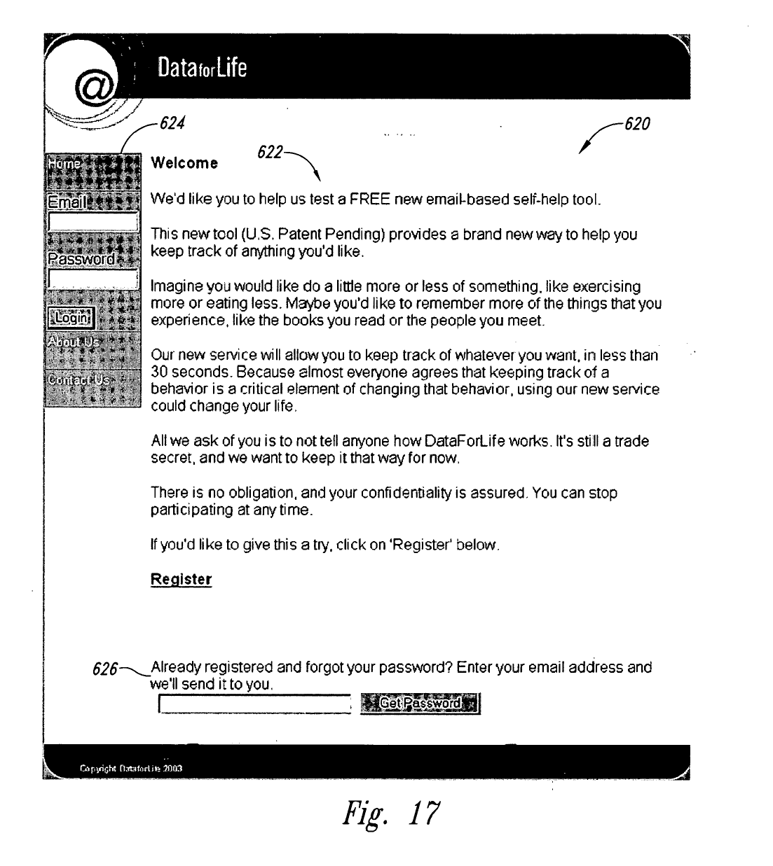

As to FIG. 17, a screenshot shows a login screen 620 with before logon welcome text 622, logon area 624 and a password registration area 626 of an implementation of the personal information system.

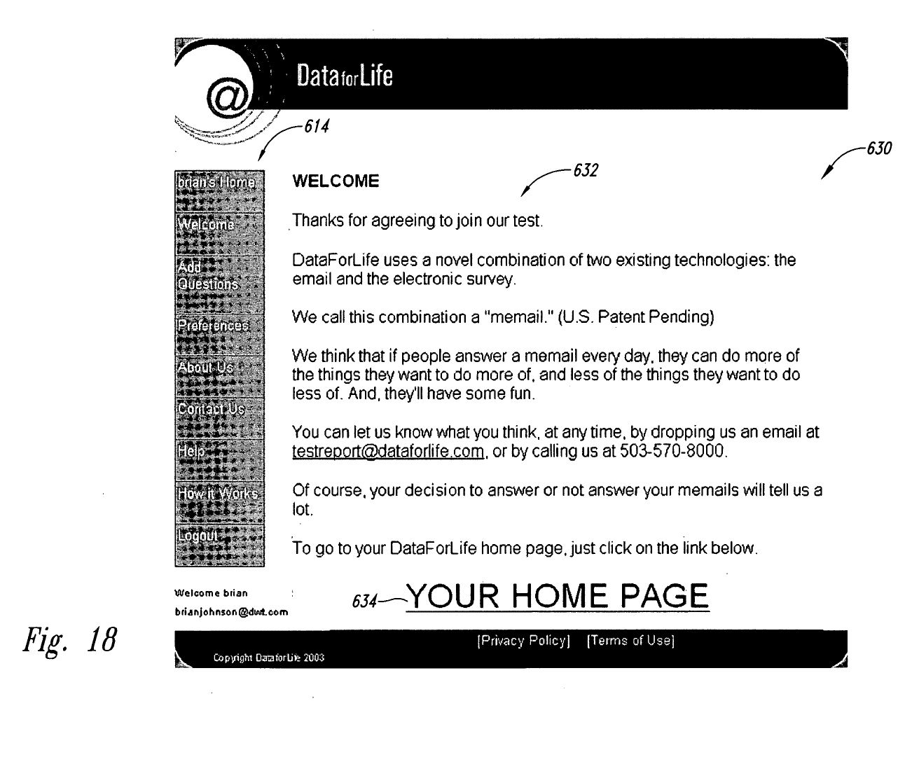

As to FIG. 18, a screenshot shows a welcome page 630 having after logon welcome text 632 and a home page link 634 to direct the user workstation 114 to the home page of the user logged on to the implementation of the personal information system.

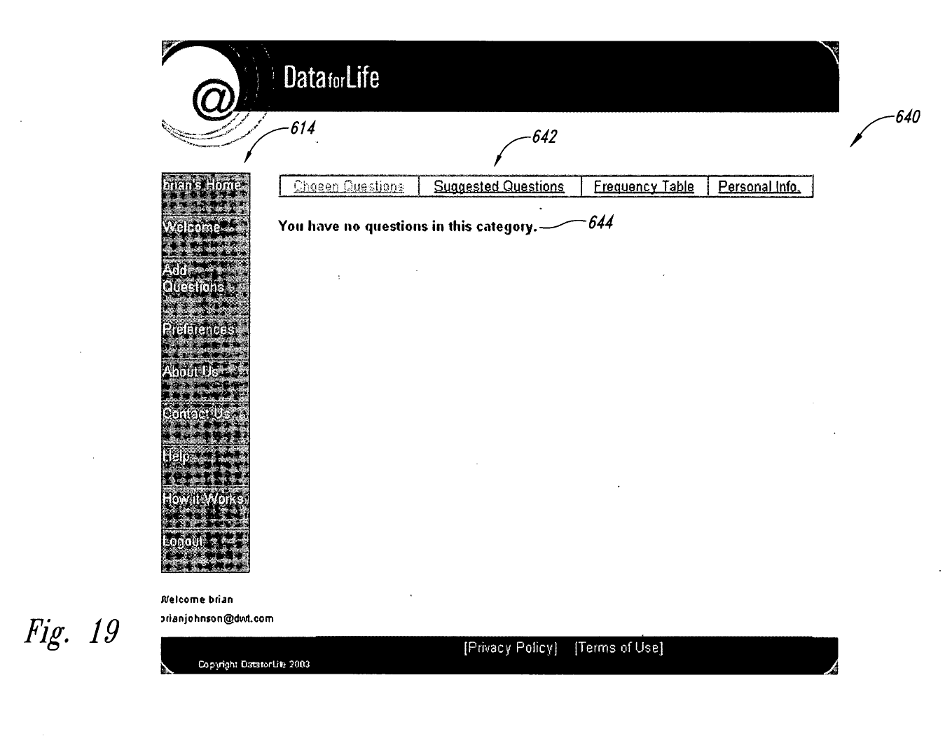

As to FIG. 19, a screenshot shows a chosen questions page 640 having a status menu 642 from which the chose questions page was chosen and status text 644 related to the existence of chosen questions of the user logged on to the implementation of the personal information system.

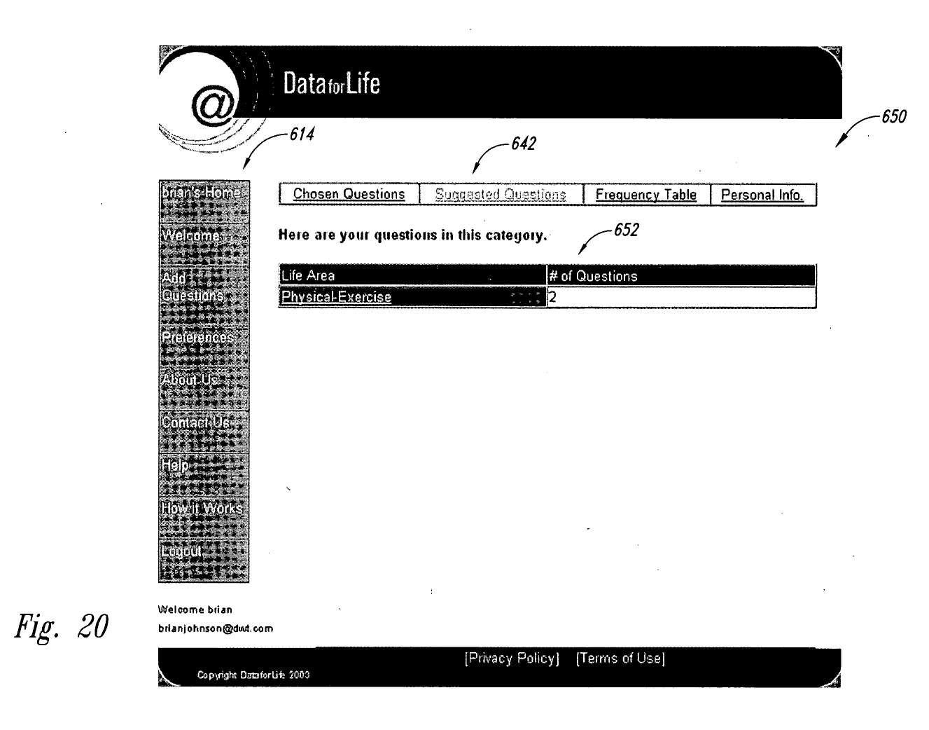

As to FIG. 20, a screenshot shows a suggested questions page 650 being displayed after a suggested questions selection of the status menu 642 was chosen. The suggested questions page 650 includes a suggested questions category display 652 of an implementation of the personal information system.

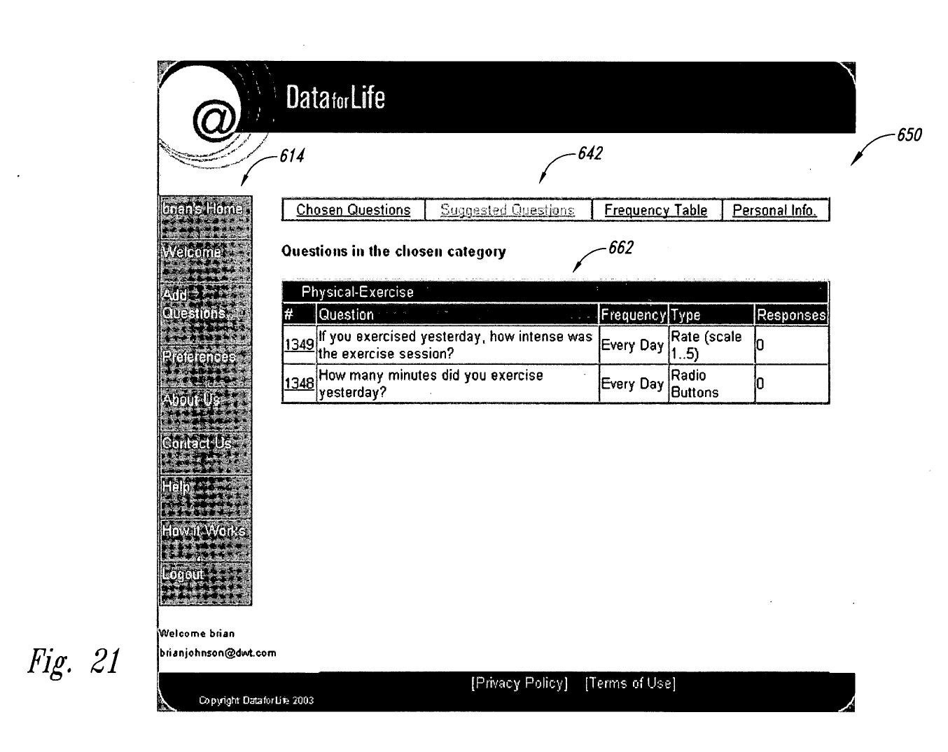

As to FIG. 21, a screenshot shows of a detailed menu 662 of the suggested questions page 650 displayed after a “physical exercise” link in the suggested questions category display 652 was selected.

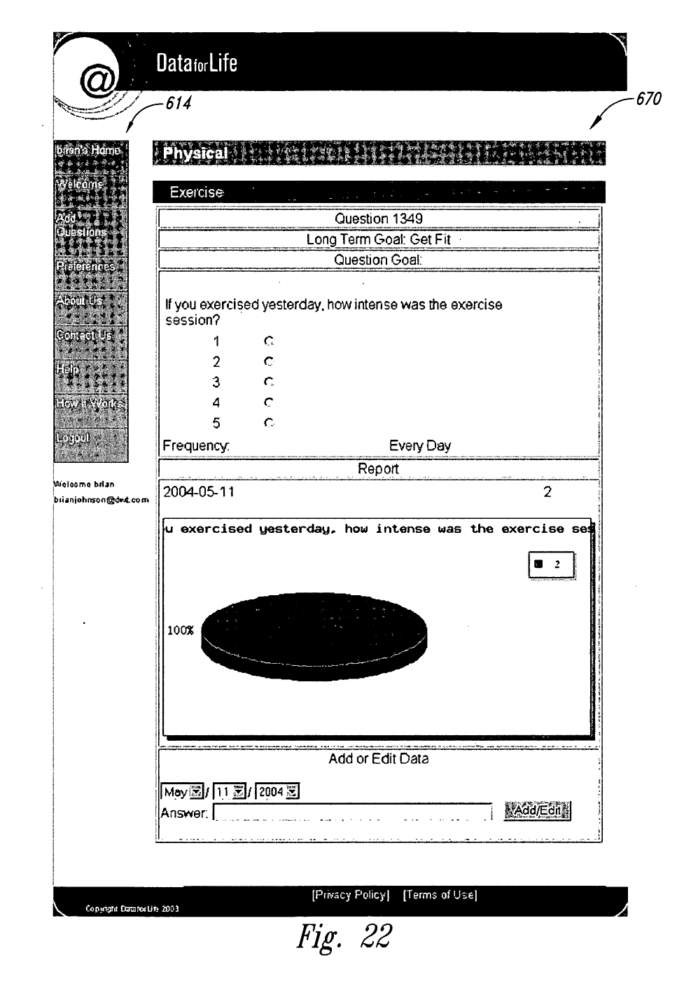

As to FIG. 22, and a screenshot shows a first question page 670 displayed after a “1349” link of the detailed menu 662 of the suggested questions page 650 was selected.

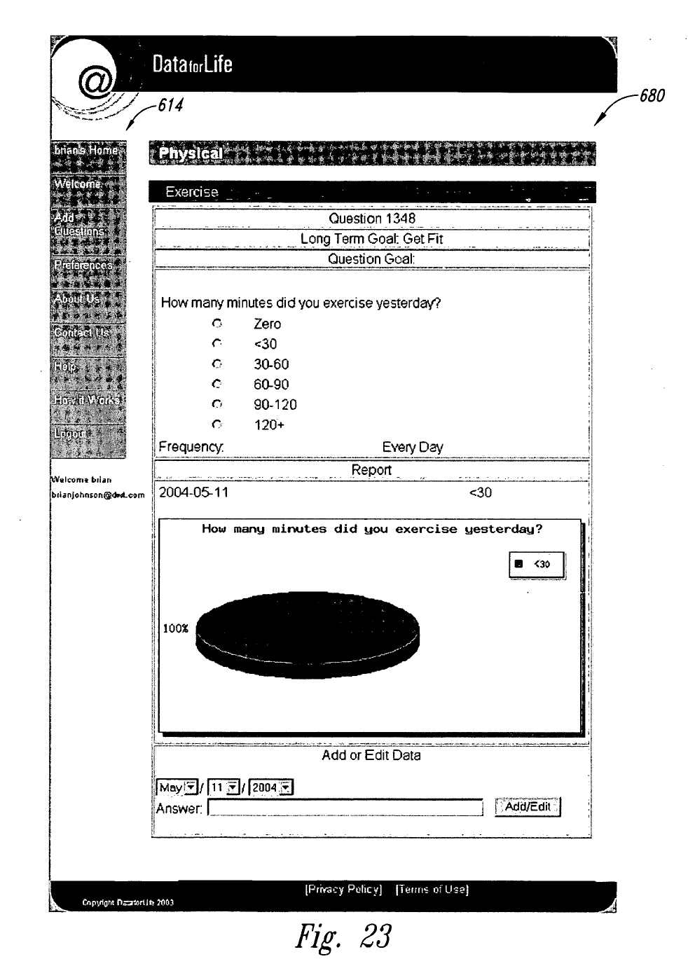

As to FIG. 23, a screenshot shows a second question page 680 displayed after a “1348” link of the detailed menu 662 of the suggested questions page was selected. FIG. 23 shows a pie chart graph of one response to this question (both a “<30”).

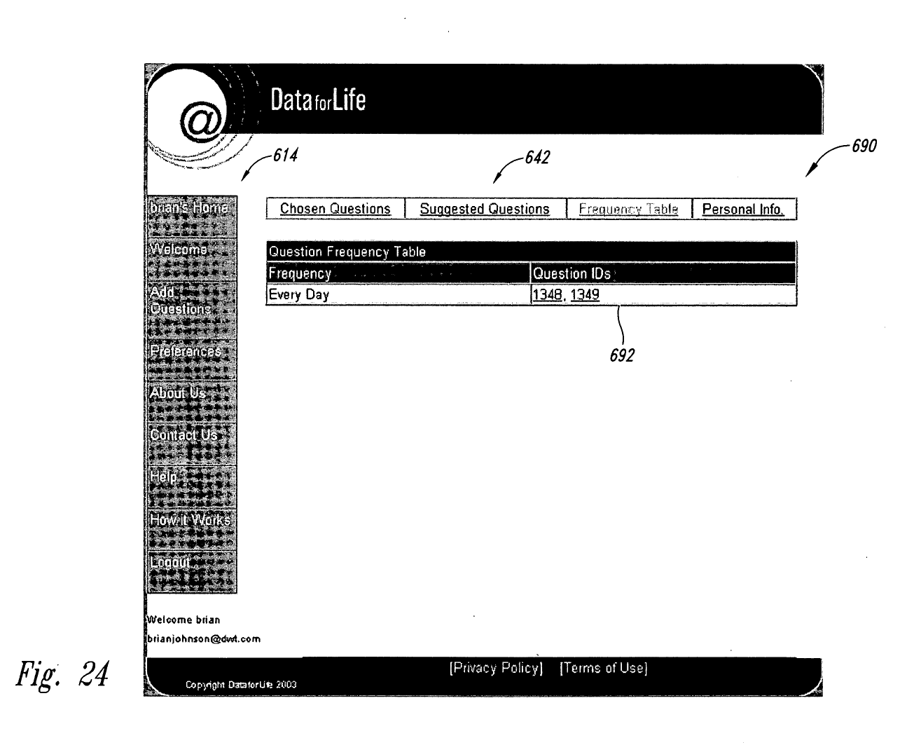

As to FIG. 24, a screenshot shows a frequency table page 690 being displayed after a frequency table selection of the status menu 642 was chosen. The frequency table page 690 includes a question frequency table 692 showing how often questions are transmitted to the user logged onto the implementation of the personal information system.

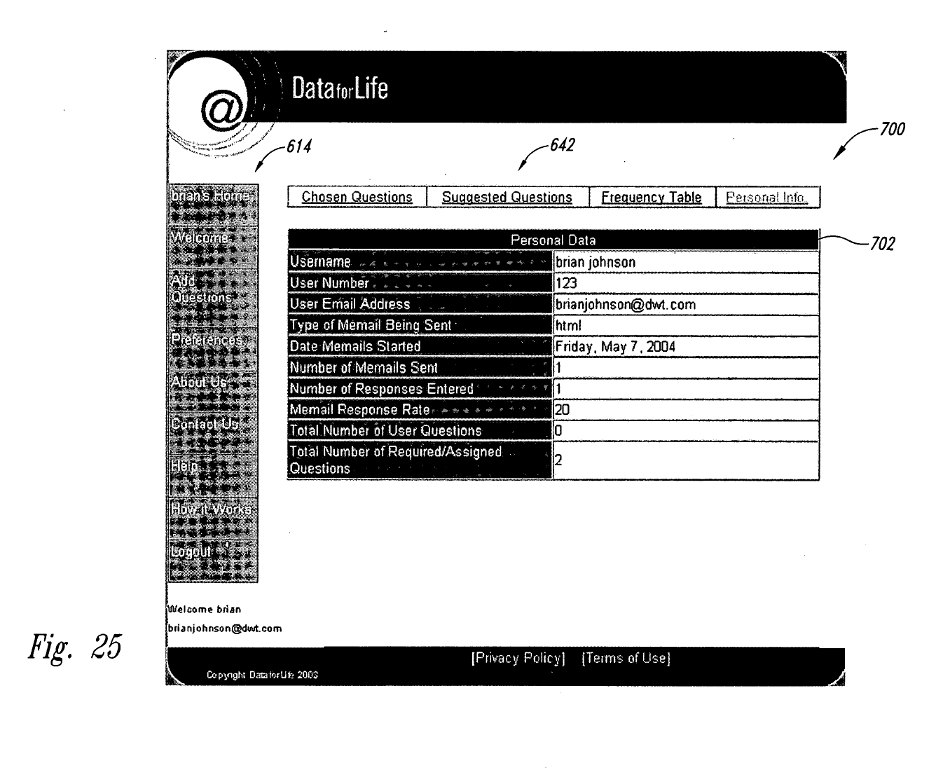

As to FIG. 25, a screenshot shows a personal info page 700 being displayed after a personal Info selection of the status menu 642 was chosen. The personal Info page 700 includes a personal data table 702 showing data of the user logged on to the implementation of the personal information system.

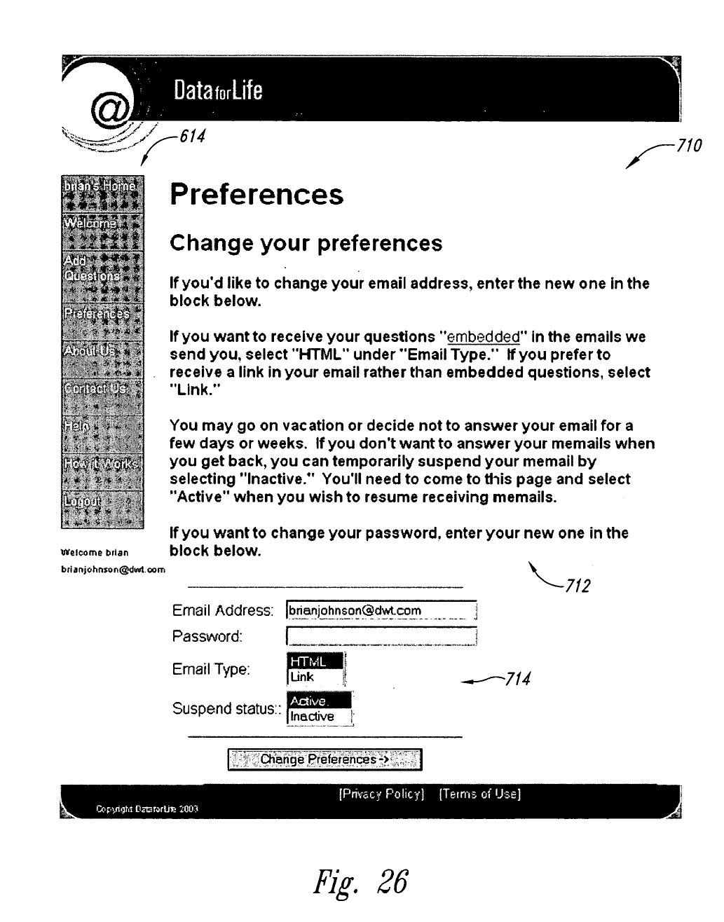

As to FIG. 26, a screenshot shows a preferences page 710 being displayed after a preferences selection of the main menu 614 was chosen. The preferences page 710 includes change preferences instructions 712 and a logon 714 to change preferences of the user logged onto the implementation of the personal information system.

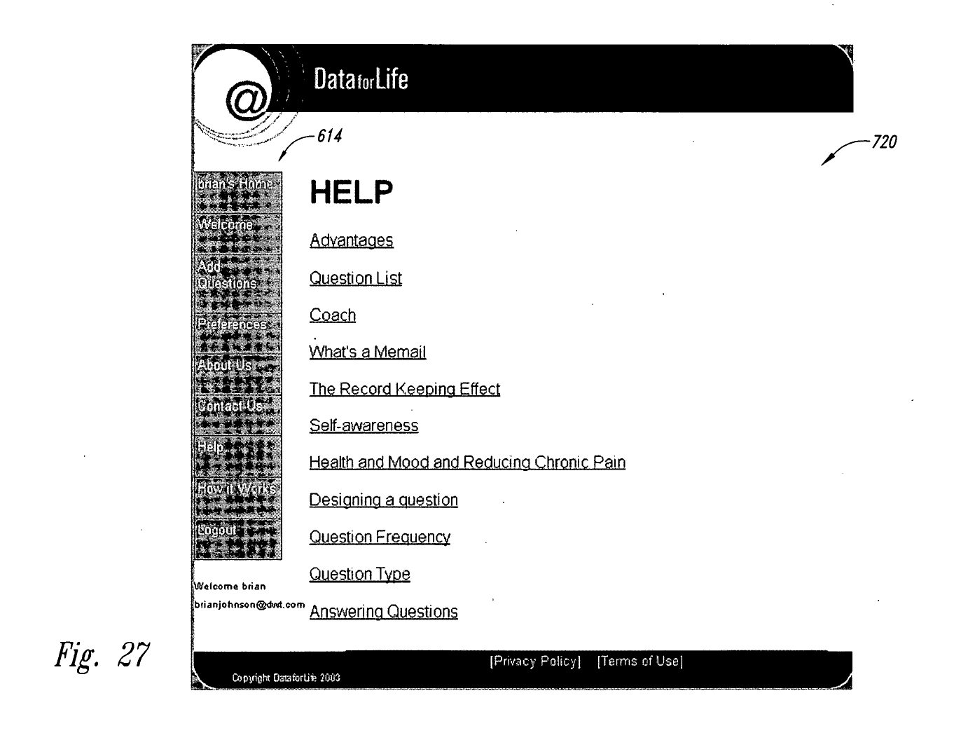

As to FIG. 27, a screenshot shows a help menu page 720 displayed after a help selection of the main menu 614 was chosen. The help menu page 720 includes help links 722 to access help arrange by topic.

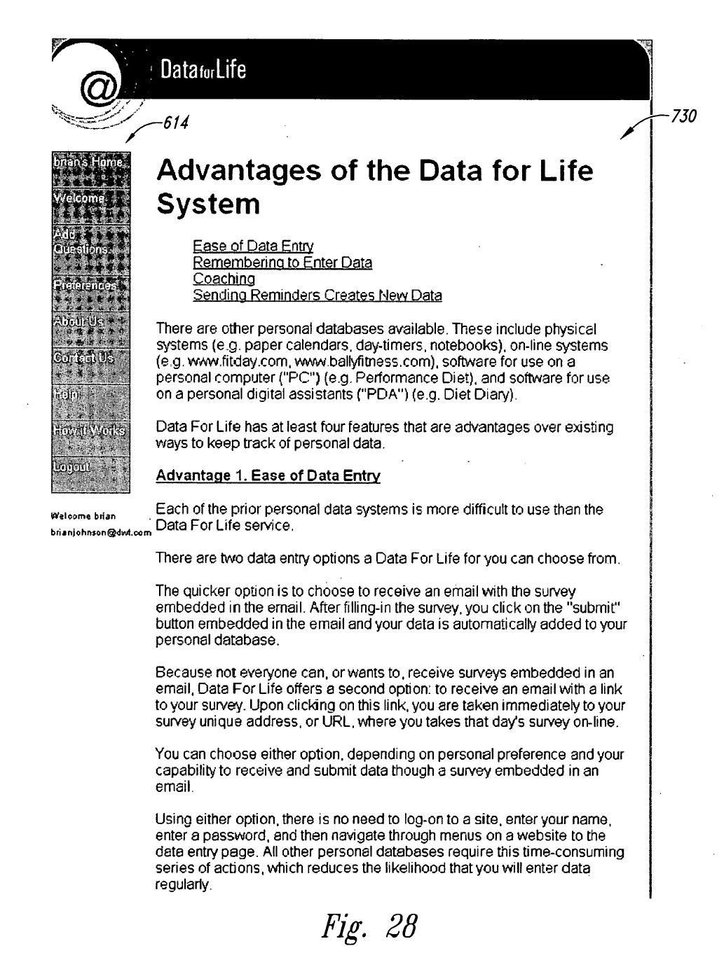

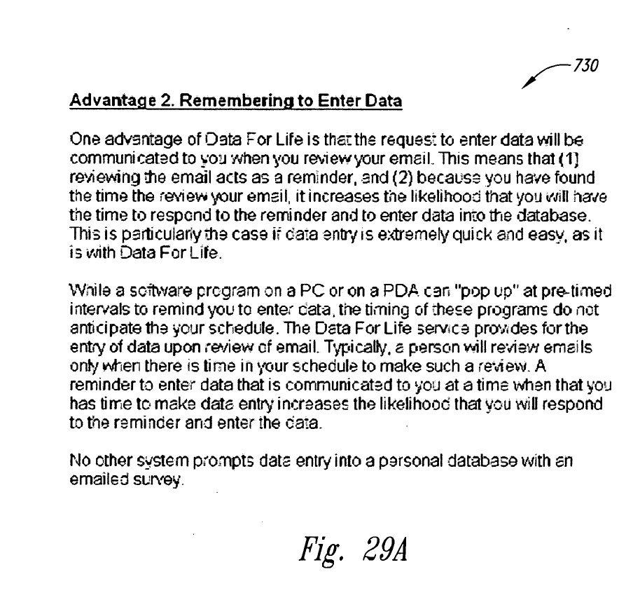

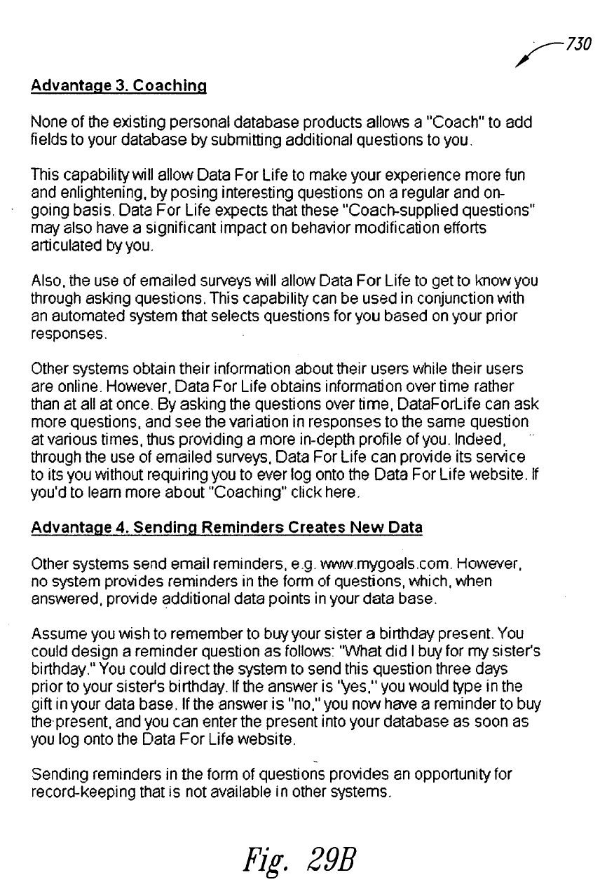

As to FIGS. 28 and 29, a screenshot show an advantages help page 730 displayed after an advantages selection of the help links 722 was chosen. The advantages help page 730 includes discussion regarding advantages of the implementation of the personal information system.

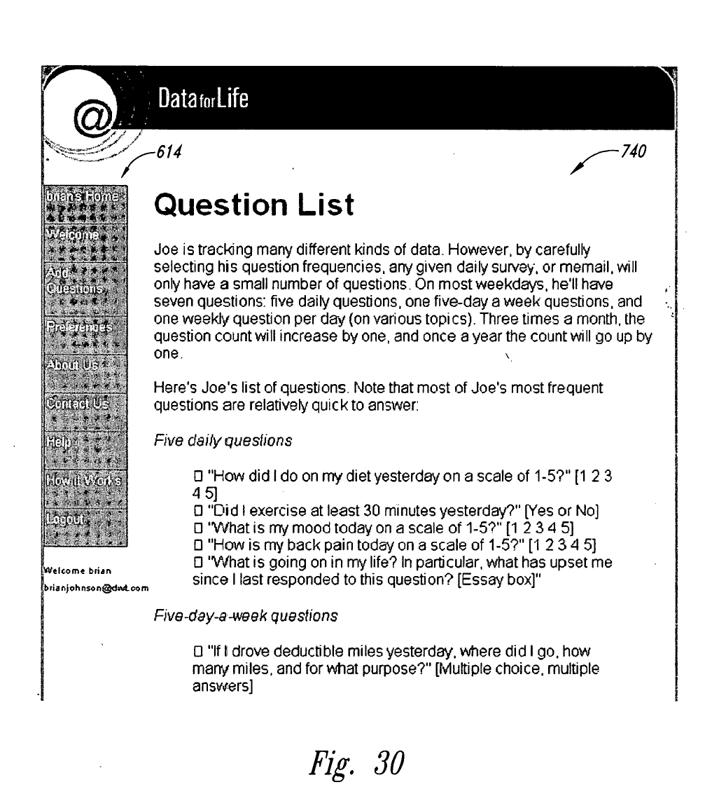

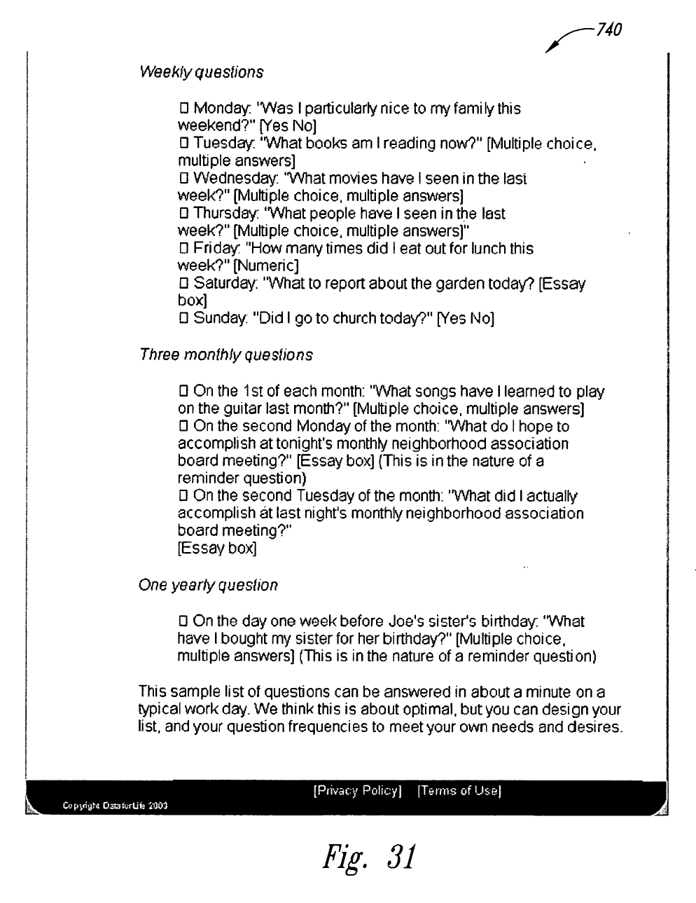

As to FIGS. 30 and 31, a screenshot shows a question list help page 740 displayed after a question list selection of the help links 722 was chosen. The question list help page 740 includes discussion regarding how questions are implemented with the implementation of the personal information system.

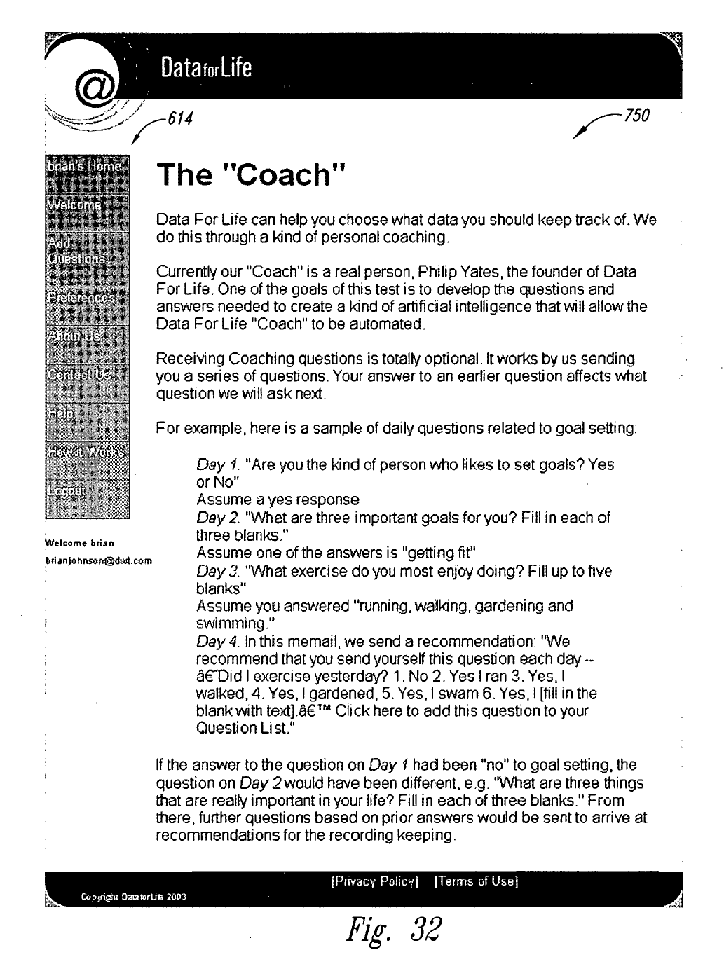

As to FIG. 32, a screenshot shows a coach help page 750 displayed after a coach help page selection of the help links 722 was chosen. The coach help page 750 includes discussion regarding how coaches are used with the implementation of the personal information system.

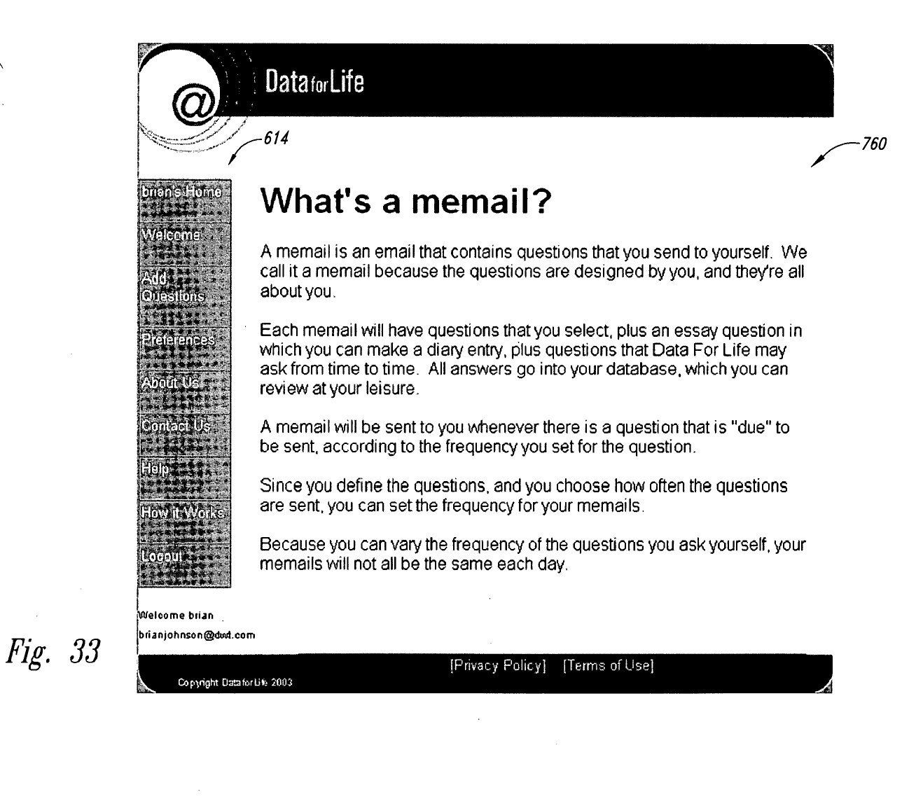

As to FIG. 33, a screenshot shows a memail help page 760 displayed after a memail selection of the help links 722 was chosen. In this implementation, a memail is a form of an imail. The memail help page 760 includes discussion regarding how a memail is used in the implementation of the personal information system.

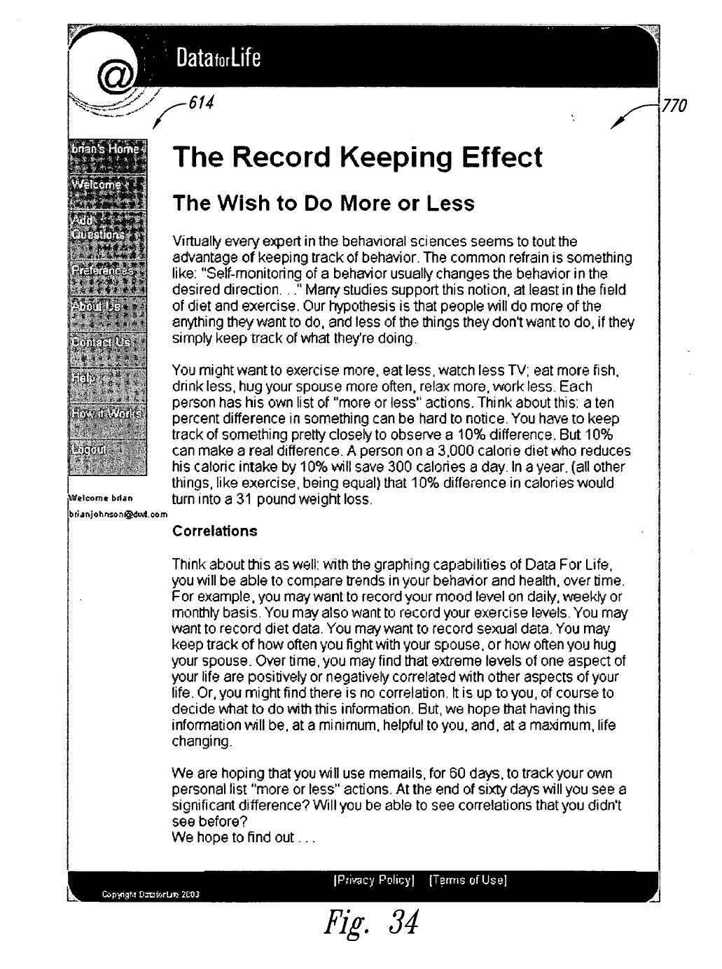

As to FIG. 34, a screenshot shows a recordkeeping help page 770 displayed after a record keeping selection of the help links 722 was chosen. The recordkeeping help page 770 includes discussion regarding advantages of keeping records with the implementation of the personal information system.

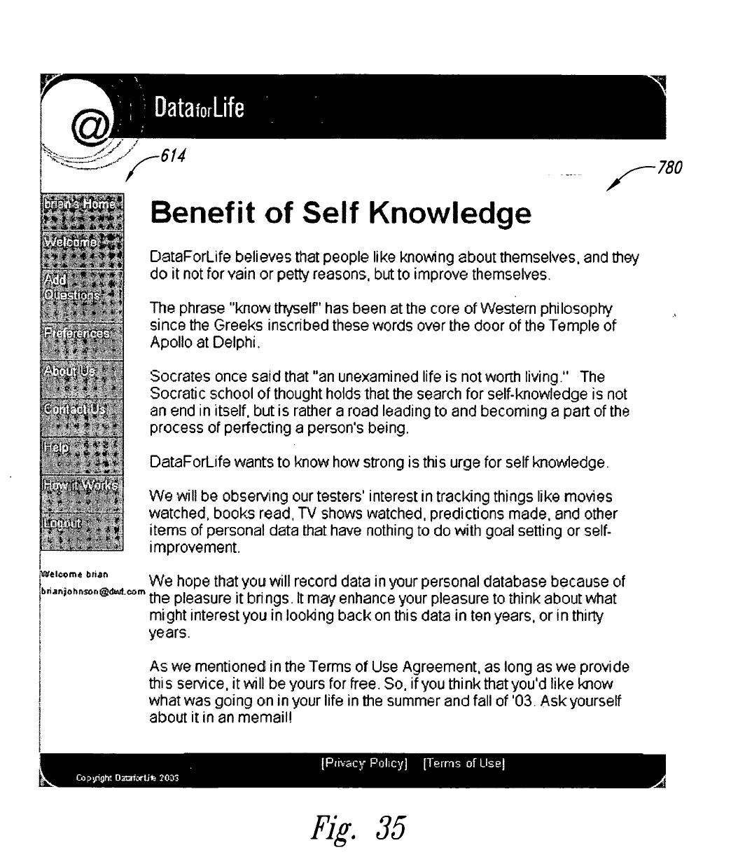

As to FIG. 35, a screenshot shows a self-knowledge help page 780 displayed after a self-awareness selection of the help links 722 was chosen. The self-knowledge help page 780 includes discussion regarding advantages the implementation of the personal information system regarding self knowledge.

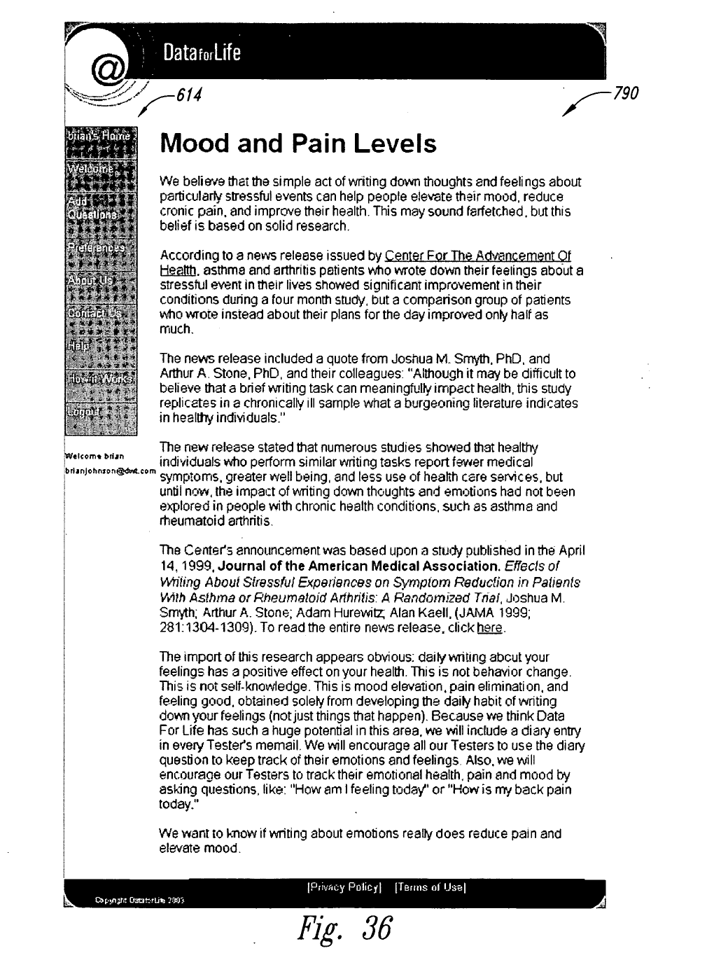

As to FIG. 36, a screenshot shows a mood and pain help page 790 displayed after a mood and pain selection of the help links 722 was chosen. The mood and pain help page 790 includes discussion regarding advantages of an implementation of the personal information system.

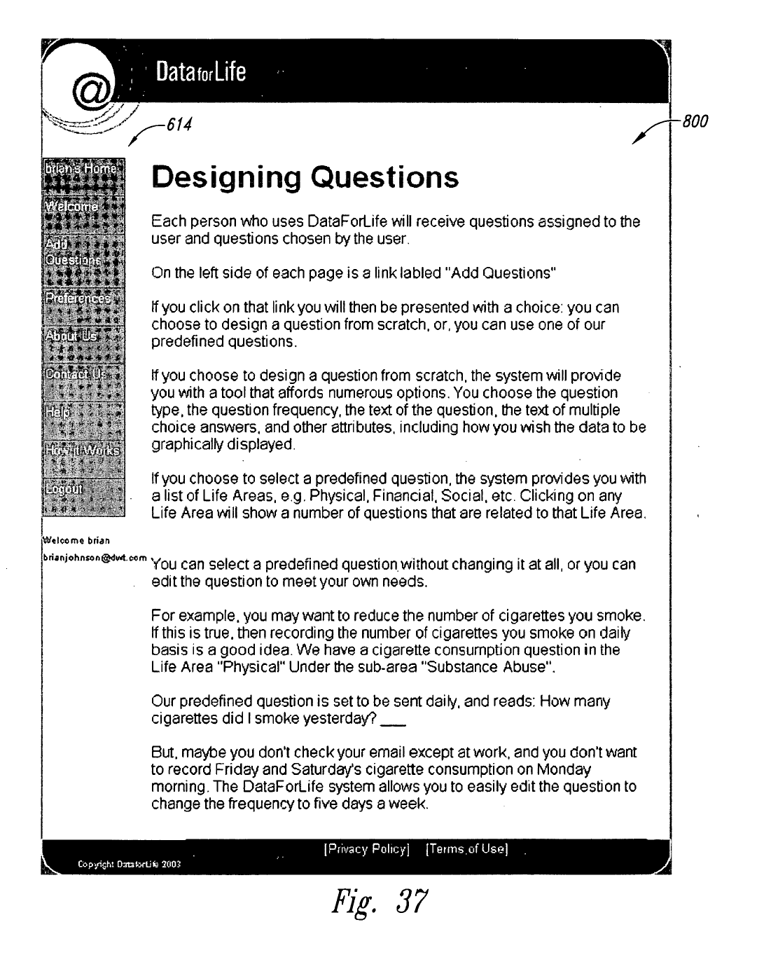

As to FIG. 37, a screenshot shows a designing questions help page 800 displayed after a designing a question selection of the help links 722 was chosen. The designing questions help page 800 includes discussion regarding aspects of designing questions to be used with the implementation of the personal information system.

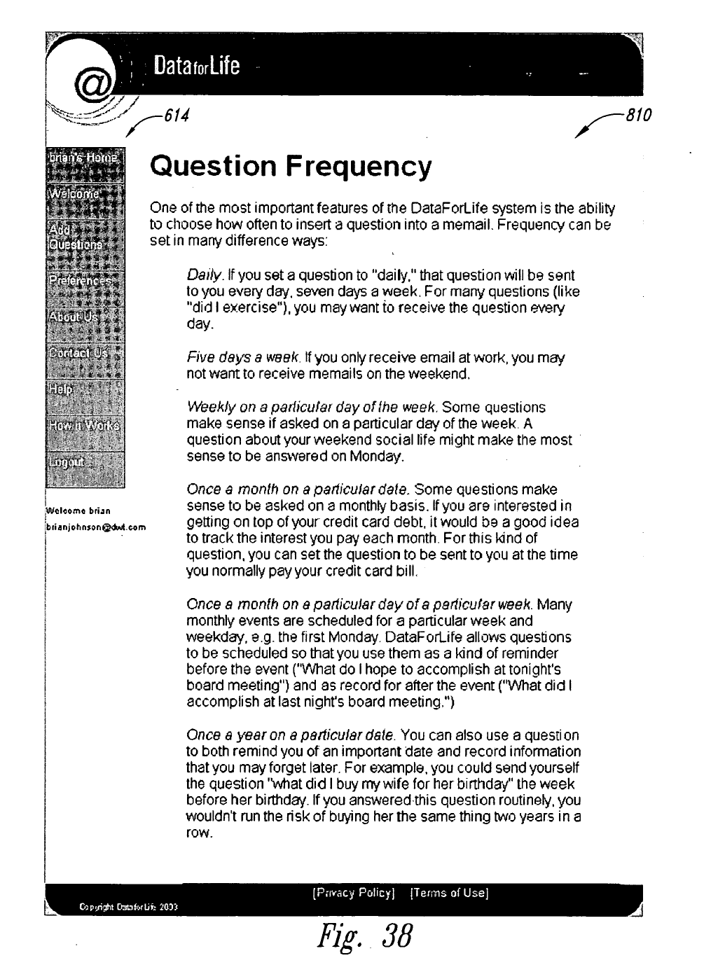

As to FIG. 38, a screenshot shows a question frequency help page 810 displayed after a question frequency selection of the help links 722 was chosen. The question frequency help page 810 includes discussion regarding selection of frequency of transmission of questions transmitted to users the implementation of the personal information system.

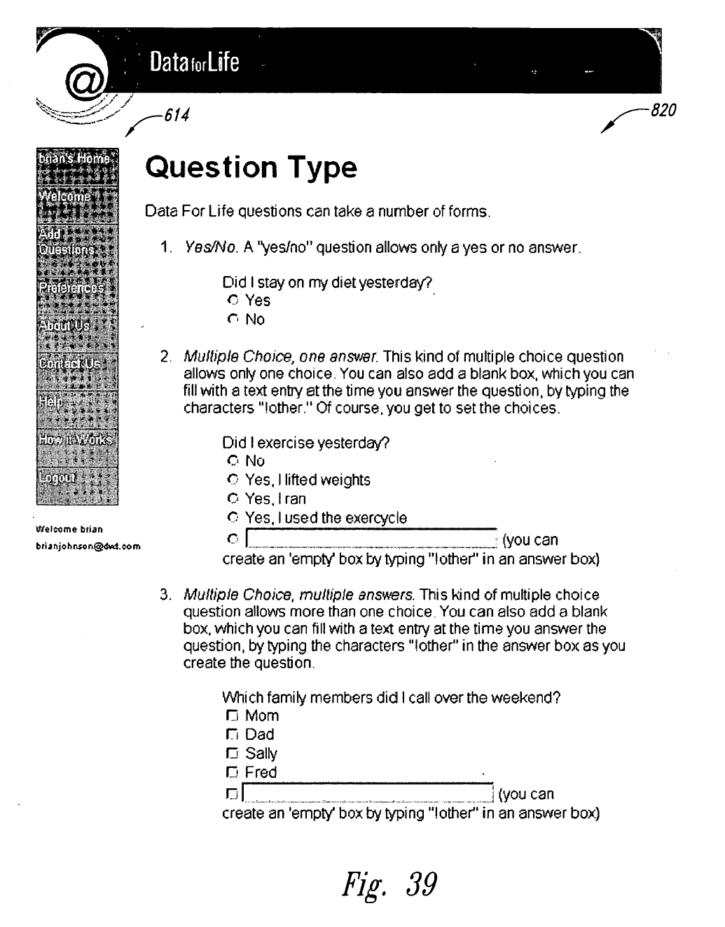

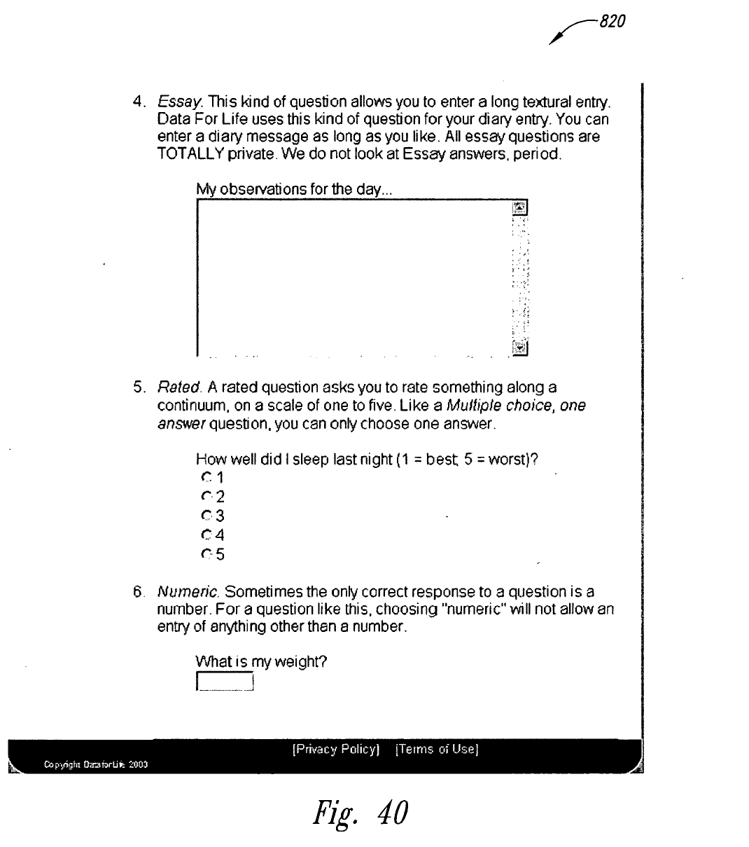

As to FIGS. 39 and 40, a screenshot shows a question type help page 820 displayed after a question type selection of the help links 722 was chosen. The question type help page 820 includes discussion regarding selection of the type of questions used with the implementation of the personal information system.

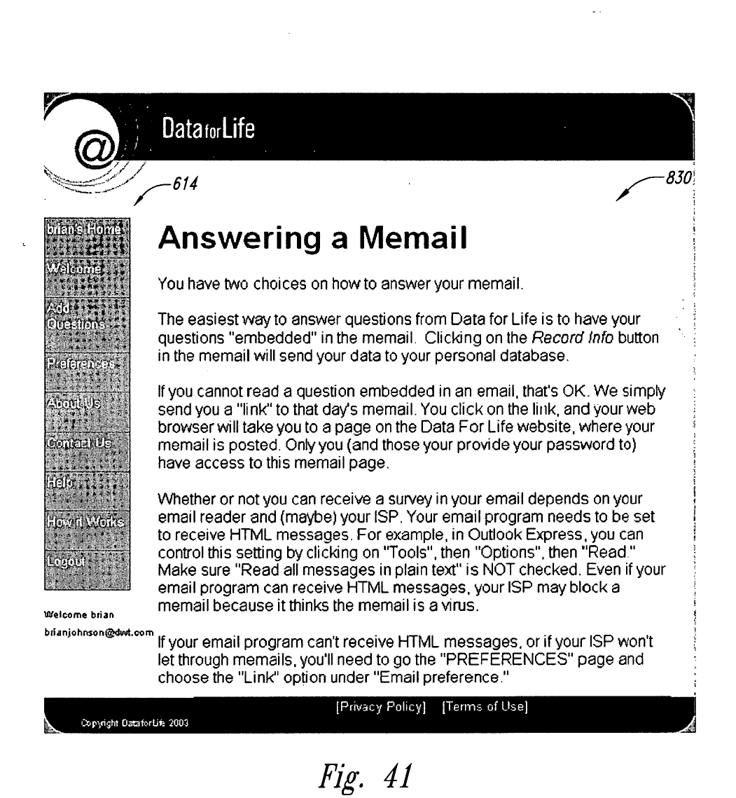

As to FIG. 41, a screenshot shows an answering memail help page 830 displayed after an answering questions selection of the help links 722 was chosen. The answering memail help page 830 includes discussion regarding how imails (memails in the particular implementation illustrated) are answered in the implementation of the personal information system.

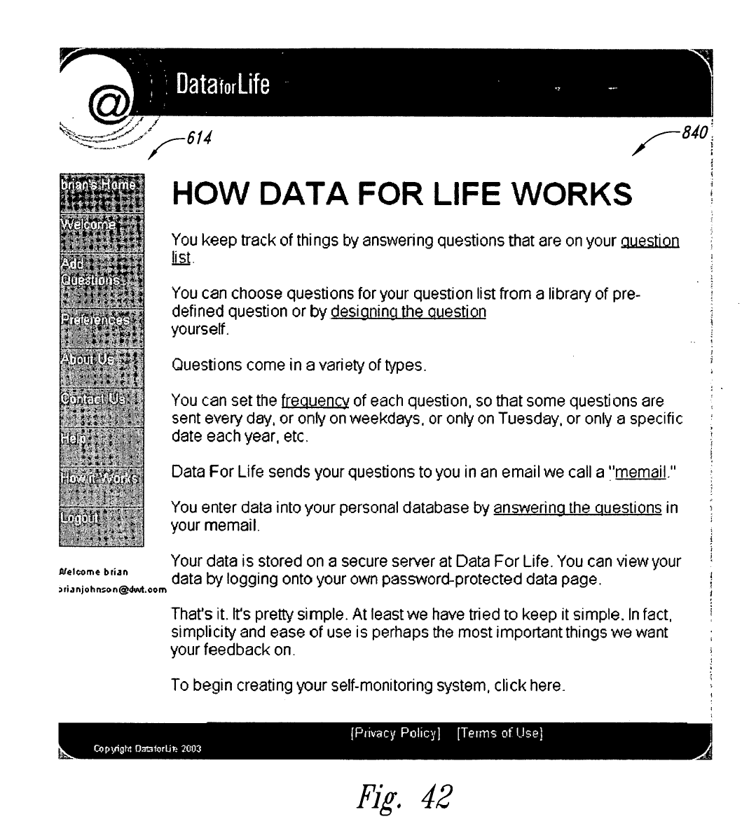

As to FIG. 42, a screenshot shows a how data for life works page 840 displayed after a how it works selection of the main menu 614 was chosen. The how data for life work page 840 includes a general discussion regarding operation of the implementation of the personal information system.

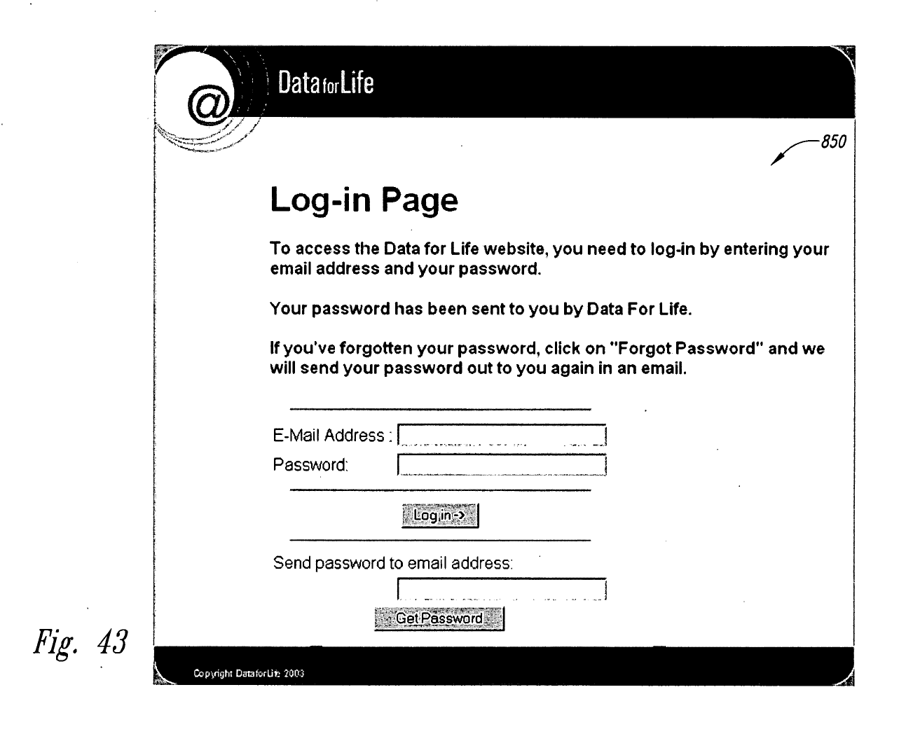

As to FIG. 43, a screenshot shows an alternative logon page 850 of an implementation of the personal information system.

The foregoing detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof. Those skilled in the art will recognize that the embodiments disclosed herein, in whole or in part, can be equivalently implemented in integrated circuits, as one or more computer programs running on one or more computers (e.g., as one or more programs running on one or more data processing systems), as one or more programs running on one or more controllers (e.g., microcontrollers) as one or more programs running on one or more processors e.g., microprocessors, as firmware, or as virtually any combination thereof, and that designing the circuitry and/or writing the code for the software and or firmware would be well within the skill of one of ordinary skill in the art in light of this disclosure. In addition, those skilled in the art will appreciate that the mechanisms of the present invention are capable of being distributed as a program product in a variety of forms, and that an illustrative embodiment of the present invention applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analogue communication links using TDM or IP based communication links (e.g., packet links).

In a general sense, those skilled in the art will recognize that the various embodiments described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and electrical circuitry forming a communications device (e.g., a modem, communications switch, or optical-electrical equipment).

Those skilled in the art will recognize that it is common within the art to describe devices and/or processes in the fashion set forth herein, and thereafter use standard engineering practices to integrate such described devices and/or processes into data processing systems. That is, the devices and/or processes described herein can be integrated into a data processing system via a reasonable amount of experimentation.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. Note: it will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A data system for communication with communication devices of entities, the data system comprising:
a database containing data including messages, at least some of the messages containing questions;
a communication exchange configured to repeatedly send the messages, with at least some being sent more than once, to one of the communication devices of one of the entities being a person registered with the data system as a user of the data system to repeatedly solicit responses from the user to be sent to the data system by the user from the one of the communication devices, and to receive the responses sent to the data system from the communication device of the user; and
a coach system configured to provide to another one of the entities being a person registered with the data system as a coach access to review the responses sent to the data system from the communication device of the user;
a financial transaction system configured to provide the user capability to make purchases using at least one of credit cards and debit cards, and to collect information regarding such purchases; and
a vendor system configured to provide to another one of the entities registered with the data system as a vendor access to review the responses received by the communication exchange from the communication device of the user, and access to review the information regarding purchases of the user and to send solicitations to the user regarding at least one of products and services for possible purchase by the user based at least in part on the reviews of the vendor.

2. The data system of claim 1 wherein the communication exchange sends the messages to the communication device of the user in accordance with a predetermined schedule.

3. The data system of claim 2 wherein the predetermined schedule is daily.

4. A data system for communication with communication devices of persons, the data system comprising:
a database containing data including messages, at least some of the messages containing questions;
a communication exchange configured to repeatedly send the message, with at least some being sent more than once, to one of the communication devices of one of the persons registered with the data system as a user of the data system to repeatedly solicit responses from the user to be sent to the data system by the user from the one of the communication devices, and to receive the responses sent to the data system from the communication device of the user; and
a coach system configured to provide to another one of the persons registered with the data system as a coach access to review the responses sent to the data system from the communication device of the user.

5. The data system of claim 4 wherein the communication exchange is further configured to format the messages for display on the communication device of the user one or more of the repeated questions of the messages with a graphical representation of prior responses to the one or more repeated question.

6. The data system of claim 4 wherein the coach system is configured to generate at least one subsequent message to be sent to the communication device of the user by the communication exchange based upon the responses received by the data system from the communication device of the user.

7. The data system of claim 4 wherein the coach system is configured to provide access for the coach to the database to modify the messages of the database to be sent to the communication device of the user.

8. The data system of claim 4 wherein the communication exchange sends the messages to the communication device of the user in accordance with a predetermined schedule.

9. The data system of claim 8 wherein the predetermined schedule is daily.

10. A data system for communication with a communication device, the data system comprising:
a database containing messages and scheduling data; and
a communication exchange configured to repeatedly send the same message of the database to the communication device according to the scheduling data.

11. The data system of claim 10 for use with a communication device configured to receive e-mails, wherein the communication exchange is configured to send the same message of the database in the form of e-mails to the communication device, and to receive email responses from the communication device.

12. The data system of claim 11 wherein the same message is in the form of a question, and wherein the communication exchange is configured to format the e-mails to provide capability to respond to the question contained in the e-mails as part of display of the e-mails on the communication device.

13. The data system of claim 10 wherein the same message is in the form of a question, and wherein the communication exchange is configured to format the e-mails in a markup language to provide capability to respond to the question within the e-mails using check boxes and submit buttons within the e-mails.

14. The data system of claim 10 wherein the communication exchange sends the same message to the communication device in accordance with a predetermined schedule.

15. The data system of claim 14 wherein the predetermined schedule is daily.

16. A personal information system comprising:
a communication device configured to be used by a user; and
a data system including a database storing data to be sent to the communication device more than once, the data including questions to be responded to more than once by the user of the communication device.

17. The personal information system of claim 16 comprising a network, and wherein the communication device and the data system are communicatively coupled to the network.

18. The personal information system of claim 17 wherein the network is a wireless network.

19. The personal information system of claim 18 wherein the communication device is a cellular telephone.

20. The personal information system of claim 18 wherein the communication device is a wireless personal data assistant.

21. The personal information system of claim 17 wherein the network is a computer data network

22. The personal information system of claim 21 wherein the communication device is a computer workstation and the data system is a computer server.

23. The personal information system of claim 21 wherein the computer network is the Internet.

24. A data system for communication with communication devices of entities, the data system comprising:
a database containing data including messages, at least some of the messages containing questions;
a communication exchange configured to repeatedly send the messages, with at least some being sent more than once, to one of the communication devices of one of the entities registered with the data system as a user of the data system to repeatedly solicit responses from the user to be sent to the data system by the user from the communication device of the user, and to receive the responses sent to the data system by the user from the communication device of the user; and
a vendor system configured to provide to another one of the entities registered with the data system as a vendor access to review the responses sent to the data system by the user from the communication device of the user, and to send solicitations to the user regarding at least one of products and services for possible purchase by the user based at least in part on the responses received by the communication exchange from the communication device of the user.

25. The data system of claim 24 wherein the vendor system is configured to generate at least one subsequent message to be sent to the communication device of the user by the communication exchange based upon the responses received by the communication exchange from the communication device of the user.

26. The data system of claim 24 comprising a financial transaction system configured to provide the user capability to make purchases using at least one of credit cards and debit cards and to collect information regarding such purchases.

27. A data system for communication with communication devices of users of the data system, the data system comprising:
a database containing user data regarding the users;
an introduction system configured to search the user data to determine if possible matches of the user data exist between at least two of the users and to transmit a message of introduction to at least one of the matched users if a match exists; and
communication exchange configured to electronically send a series of messages to communication devices of selected ones of the users soliciting a series of responses, each response to contain a portion of the user data to be stored in the database.

28. A method comprising:
repeatedly transmitting a message via e-mail to a workstation of a user wherein each transmission of the e-mail message solicits a response from the user containing information related to the particular transmissions to the user;
electronically receiving responses from the user to the repeated transmissions of the message, the responses containing the information solicited from the user; and
including at least some of the information solicited from the user in subsequent repeated transmissions of the message to the user.

29. The method of claim 28 wherein the message contains questions and comprising generating at least one of modifications to the questions and additional questions to be added to the message based upon prior responses received from the user.

30. The method of claim 28 wherein the including at least some of the information is done by including a graphical representation of the information within the repeated e-mail transmissions of the message.

31. A method comprising:
storing data regarding a person in a database as a user;
storing data in the database of a person as a coach of the user;
repeatedly transmitting an electronic based message to the user to solicit responses containing information related to the particular transmission of the message to the user;
electronically receiving responses from the user to the repeated transmissions of the message, the responses containing the information solicited from the user; and
modifying subsequent transmissions of the electronic based message based upon at least one review by the coach of the received information solicited from the user.

32. A method comprising:
electronically storing questions to be sent by e-mail to a person;
electronically storing a frequency of when the questions will be sent to the person;
sending selected ones of the questions by e-mail to the person at the stored frequency;
receiving responses containing information from the person to the questions; and
sending to the person by e-mail at least one of modifications to the questions or additional questions based upon the received information.

33. A method comprising:
repeatedly transmitting a message via e-mail to a workstation of a user wherein each transmission of the e-mail message solicits a response from the user containing information related to the particular transmissions to the user;
electronically receiving responses from the user to the repeated transmissions of the message, the responses containing the information solicited from the user; and
sending at least one message to the workstation of the user soliciting the user to purchase based at least in part upon the information solicited from the user.

34. The method of claim 33 comprising monitoring at least one of credit and debit card purchases of the user to collect financial transaction information, and wherein the sending at least one message to the workstation of the user soliciting the user to purchase is also based at least in part upon at least a portion of the collected financial transaction information.

35. A method comprising:
electronically registering a coach, the coach having a team of members;
periodically sending e-mails to the team members soliciting information;
electronically receiving solicited information from the team members;
electronically registering a vendor;
sending at least one vendor marketing message to the team members based at least in part upon at least a portion of the received solicited information from the team members;
collecting from the vendor a fee based at least in part upon the sending at least one vendor marketing message to the team members; and
distributing at least a portion of the fee to the team members.

36. A method comprising:
electronically sending messages to users, each message soliciting information containing a portion of predetermined user data for the receiving user until all portions of the user data for each user have been solicited by one of the messages;
electronically receiving responses from the users, each of the responses containing the portion of user data solicited;
storing the received portions of user data until each user has complete user data with all portions of user data stored;
searching complete portions of user data for a portion of the users to determine if matches exist; and
notifying at least one of the matching users that a match exists.
